(19) United States
(12) Patent Application Publication
(10) Pub. No.: US 2026/0165819 A1
(43) Pub. Date: Jun. 18, 2026

(54) SYSTEMS, APPARATUS, AND METHODS FOR FABRICATING DENTAL APPLIANCES WITH ADVANCED PATIENT SPECIFIC FEATURES

(71) Applicant: ALIGN TECHNOLOGY, INC., San Jose, CA (US)

(72) Inventors: James NISHIMUTA, Durham, NC (US); Trent Nathaniel MORTON, Cary, NC (US); Sudharshan ANANDAN, Sunnyvale, CA (US); Yuxiang WANG, Newark, CA (US); David TURNER, Durham, NC (US); Ravi Rasik PATEL, Raleigh, NC (US); Yueping WANG, San Jose, CA (US); Crystal TJHIA, Sunnyvale, CA (US); Viktor PONOMAREV, Moscow (RU); Ken WU, San Jose, CA (US); Danial KIA, San Jose, CA (US); Eric YAU, Santa Clara, CA (US); Jun SATO, San Jose, CA (US)

(21) Appl. No.: 19/374,683

(22) Filed: Oct. 30, 2025

Related U.S. Application Data
(60) Provisional application No. 63/714,752, filed on Oct. 31, 2024.

(51) Int. Cl. A61C 7/08; A61C 7/00; B33Y 80/00

(52) U.S. Cl. CPC A61C 7/08; B33Y 80/00; A61C 7/002; A61C 2201/002

(57) ABSTRACT

An orthodontic treatment system may include a plurality of sets of polymeric orthodontic appliances. Each of the orthodontic appliances including a plurality of tooth receiving cavities formed in the appliance shaped to move teeth of a patient from a first arrangement towards a second arrangement. Each of the sets of polymeric appliances may be for a stage of orthodontic treatment. The system may include a first occlusal block on a first appliance of a first set of the plurality of sets. The first appliance may be configured for use on a first arch of the patient and the first occlusal block may include a first surface having a first shape that matches an occlusal surface of the arch on which the appliance is configured to be placed.

### RELATED APPLICATIONS

This application claims the benefit under 35 U.S.C. § 119(e) of U.S. Provisional Ser. No. 63/714,752 , filed Oct. 31, 2024, which is incorporated, in its entirety, by this reference.

### BACKGROUND

Dental treatments may involve procedures for repositioning misaligned teeth and changing bite configurations for improved cosmetic appearance and/or dental function. Repositioning can be accomplished, for example, by applying controlled forces to one or more teeth and/or the jaw over a period of time.

Orthodontic repositioning of teeth may be achieved through the use of orthodontic repositioning appliances. Such appliances may utilize a thin shell of material having resilient properties, referred to as an “aligner,” that applies tooth repositioning forces to incrementally repositions the patient's teeth and jaw repositioning forces to reposition the patient's jaw.

Placement of such an appliance over the teeth may provide controlled forces in specific locations to gradually move the teeth into a new configuration. Repetition of this process with successive appliances can move the teeth through a series of intermediate arrangements towards a final arrangement.

In various instances, teeth of a patient's upper jaw and teeth of the patient's lower jaw may contact in an incorrect or suboptimal manner (e.g., crowding, crossbite, deep bite). A proper fit of the occlusal surfaces of the teeth is helpful for proper biting and chewing, as well as desirable for aesthetic appearance. Incorrect or suboptimal contact may result in premature wear of the teeth, undesirable flexion of the teeth, and/or undesirable forces on dental restorations may be experienced by the patient.

A proper fit can be a function of the relative positions of teeth and the mandible and maxilla. The jaw may be repositioned by retrusion or protrusion to reach a desired position. The maxilla (e.g., the upper jaw) is a bone that is fixed to the skull. The mandible (e.g., lower jaw) is a bone that is attached to the skull by numerous muscles which guide its movement. The mandible articulates at its posterior upward extremities with the temporal bone to form the jaw joint. The jaw joint is a loosely connected joint that accommodates the variety of movements of the mandible relative to the maxilla during biting and chewing motions. The numerous muscles attaching the mandible to the skull control and power the complex movements involved in biting and chewing. Because the temporomandibular joint affords some flexibility in the positioning of the jaw, the lower jaw of a patient can be intentionally repositioned by using an oral appliance. While orthodontic tooth movements can change the positions of individual teeth.

In various instances, a tooth and jaw may be subject to more than one type of movement or treatment. As one example, a patient may be treated with mandibular adjustments along with orthodontic adjustments of a tooth using attachments on which an occlusal block or buccal wing may be located. Prior approaches to mandibular repositioning can be less than ideal in at least some respects. For example, generic and prefabricated occlusal blocks may be fit a patient's arch or treat the patient as well as desired and an orthodontic aligner, such as a thermoformed aligner, may not be able to apply orthodontic movement forces or provide many desired and newly contemplated orthodontic functions.

In light of the above, improved orthodontic devices that overcome at least some of the above limitations of the prior devices would be helpful.

### SUMMARY

The present disclosure is generally related to the design and fabrication of dental appliances having advanced directly fabricated features for use in treating malocclusions with oral appliances, such as for mandibular relocation, tooth eruption, and other orthodontic functions. Embodiments of the present disclosure provide improved oral appliances for mandibular relocation and orthodontic tooth movements with improved treatment outcomes.

### BRIEF DESCRIPTION OF THE DRAWINGS

A better understanding of the features, advantages and principles of the present disclosure will be obtained by reference to the following detailed description that sets forth illustrative embodiments, and the accompanying drawings of which:

FIGS. 1A and 1B depict patient specific occlusal blocks, in accordance with some embodiments.

FIGS. 2A, 2B, and 2C depict patient specific occlusal blocks, in accordance with some embodiments.

FIG. 3 depicts a patient specific occlusal block on a same tooth as an attachment, in accordance with some embodiments.

FIGS. 4A and 4B depict occlusal blocks, in accordance with some embodiments.

FIG. 5 depicts a patient specific occlusal blocks, in accordance with some embodiments.

FIGS. 6A and 6B depict patient specific occlusal blocks, in accordance with some embodiments.

FIG. 7 depicts anterior occlusal blocks, in accordance with some embodiments.

FIG. 8 depicts anterior occlusal blocks, in accordance with some embodiments.

FIG. 9 depicts anterior occlusal blocks, in accordance with some embodiments.

FIG. 10 depicts anterior occlusal blocks and occlusal attachments, in accordance with some embodiments.

FIG. 11 depicts occlusal blocks with interior retention features, in accordance with some embodiments.

FIG. 12 depicts occlusal blocks with interior retention features, in accordance with some embodiments.

FIG. 13 depicts occlusal blocks with interior retention features, in accordance with some embodiments.

FIG. 14 depicts occlusal blocks with interior retention features, in accordance with some embodiments.

FIGS. 15A and 15B depict aligners with wings, in accordance with some embodiments.

FIG. 16 depicts wings with compliant features, in accordance with some embodiments.

FIG. 17 depicts wings with wing-to-wing couplings, in accordance with some embodiments.

FIG. 18 depicts a wing with an encapsulated compliance indicator and an attachment receiving cavity, in accordance with some embodiments.

FIG. 19 depicts aligners with occlusal blocks and buttons, in accordance with some embodiments.

FIG. 20A depicts an aligner with occlusal blocks and extensions for widening interproximal gaps, in accordance with some embodiments.

FIG. 20B depicts an aligner with occlusal blocks and extensions for maintaining interproximal gaps, in accordance with some embodiments.

FIG. 21 depicts aligners with occlusal blocks having sloped occlusal surfaces, in accordance with some embodiments.

FIG. 22 depicts an aligners with occlusal blocks forming a tooth receiving cavity with an occlusal gap, in accordance with some embodiments.

FIG. 23 depicts aligners with laterally extending wings, in accordance with some embodiments.

FIG. 24 depicts aligners with blocks having laterally extending sides, in accordance with some embodiments.

FIG. 25 depicts aligners with blocks having interlocking occlusal surfaces, in accordance with some embodiments.

FIG. 26 depicts aligners with wings having shapes designed based on jaw scans, in accordance with some embodiments.

FIG. 27 depicts aligners with occlusal blocks having internal arch support structures, in accordance with some embodiments.

FIG. 28 depicts aligners with buccal structures, in accordance with some embodiments.

FIG. 29 depicts aspects of a customizable wing, in accordance with some embodiments.

FIG. 30 depicts aspects of aligners with an occlusal block having internal rib supports, in accordance with some embodiments.

FIG. 31 depicts aspects of aligner and occlusal blocks with compliant features, in accordance with some embodiments.

FIG. 32 depicts aspects of an aligner having an occlusal block and wings, in accordance with some embodiments.

FIG. 33 depicts a tooth repositioning appliance, in accordance with some embodiments.

FIG. 34 depicts a tooth repositioning system, in accordance with some embodiments.

FIG. 35 depicts a method of orthodontic treatment, in accordance with some embodiments.

FIG. 36 illustrates a method for digitally planning an orthodontic treatment and/or design or fabrication of an appliance, in accordance with some embodiments.

FIG. 37 a simplified block diagram of a data processing system, in accordance with some embodiments.

FIG. 38 depicts a method for orthodontic treatment, in accordance with some embodiments

### DETAILED DESCRIPTION

The following detailed description provides a better understanding of the features and advantages of the systems apparatus, and methods described in the present disclosure in accordance with the embodiments disclosed herein. Although the detailed description includes many specific embodiments, these are provided by way of example only and should not be construed as limiting the scope of the inventions disclosed herein.

The systems, methods, apparatus, oral appliances, and advanced aligner features disclosed herein are well suited for combination with prior devices such as aligners to reposition teeth, for example the Invisalign system commercially available from Align Technology, Inc. For example, a plurality of appliances can be sequentially placed on a patient's dentition to elicit tooth and/or movement jaw movement over incremental sequential stages of treatment including movement of teeth having mandibular features, such as occlusal block and wings having patient specific and advanced features.

The aligners are well suited for easy design and manufacturing of patient specific and advanced with varying geometries, including various sizes and shapes, to account for changes in the patient's dentition and jaw during treatment.

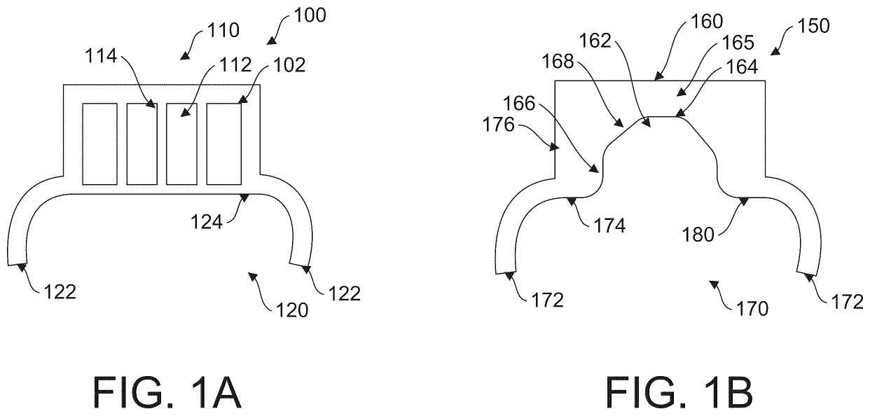

FIGS. 1A and 1B shows examples of orthodontic aligners having occlusal blocks for adjusting the relationship between the upper and lower jaws of the patient. FIG. 1A depicts a buccal-lingual cross section of the tooth receiving cavity 120 of an aligner 100. A tooth-receiving cavity in an orthodontic aligner is a cavity within the aligner that fits over a tooth. The tooth receiving cavity 120 is molded to exert controlled forces on the tooth to help to move the tooth from an initial position towards a desired or target position. The tooth receiving cavity is designed to snugly fit over the tooth to help retain the aligner on the tooth and exert the tooth movement forces to affect orthodontic treatment. Tooth receiving cavity 120 may be defined by one or more side walls 122 and an occlusal surface 124.

The occlusal block 110 aids in adjusting the relationship between the upper and lower jaws of the patient. For example, occlusal blocks may be used in mandibular advancement. Mandibular advancement refers to the forward repositioning of the lower jaw relative to the upper jaw. This technique is often used to treat certain orthodontic issues, such as an overbite, where the upper teeth significantly overlap the lower teeth. By advancing the mandible jaw alignment and occlusal contacts may be corrected.

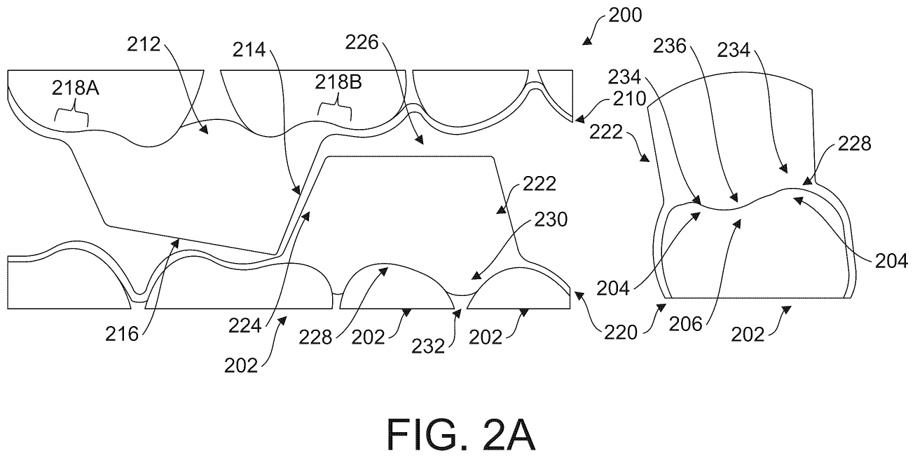

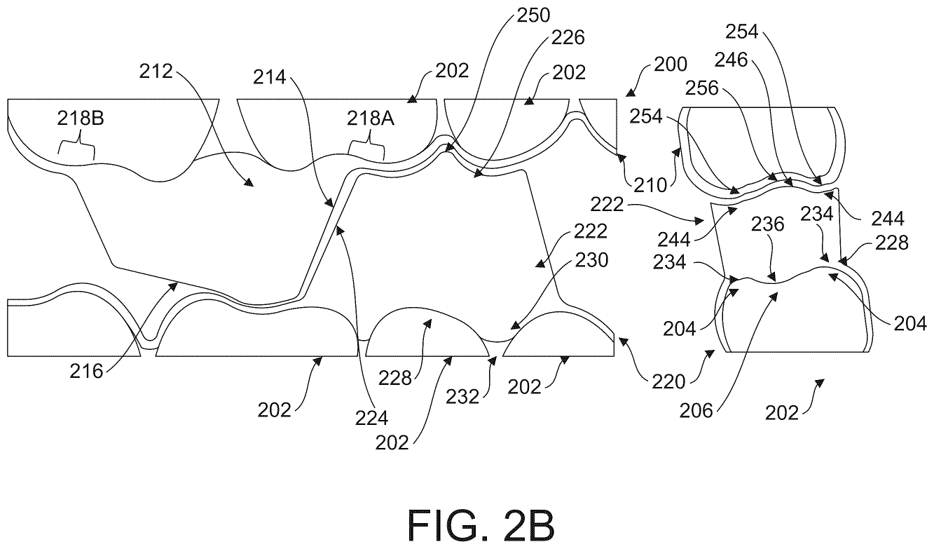

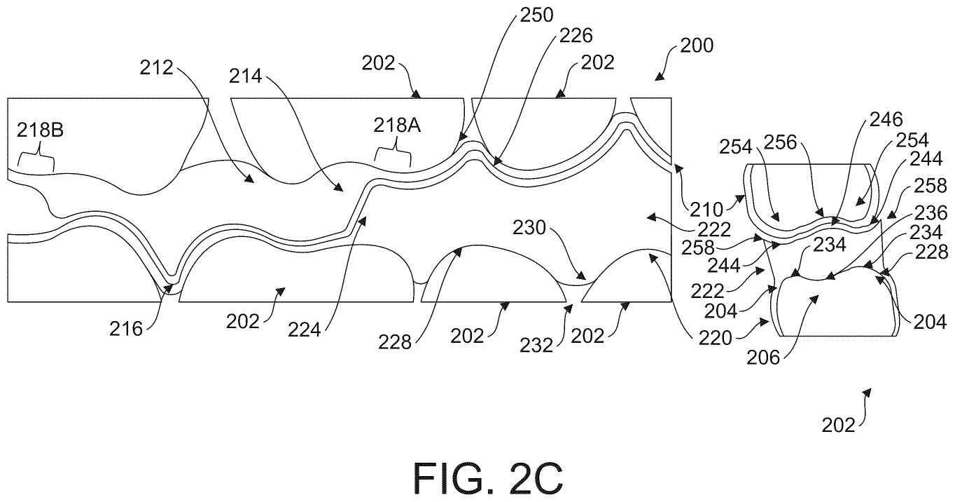

Occlusal blocks are features that may be incorporated into orthodontic aligners to facilitate mandibular advancement. Occlusal blocks may extend from the occlusal surfaces of the aligners, such as from the occlusal surfaces of the molars and premolars. Occlusal blocks can be located on an upper aligner, lower aligner, or both, depending on the patient's malocclusion and the treatment plan. Occlusal blocks create an elevated platform that extends the occlusal surface of an aligner in an occlusal direction and may have mesial-distal facing surfaces (such as engagement surfaces 224 and 214 in FIG. 2A) that exert jaw movement forces to alter the natural bite of the patient when the aligners are worn. The design and thickness of occlusal blocks are customized to each patient's needs to effect mandibular advancement.

When the patient wearing aligners having occlusal blocks closes their mouth, the occlusal blocks on the upper and lower aligners interact in a way that encourages the lower jaw to move forward, such as through contact of the engagement surfaces on the respective occlusal blocks. This interaction adjusts the relationship between the upper and lower jaw and over time causes changes in the patient's anatomy so that over time the aligners gradually reposition the natural location of the mandible into a more forward position to correct the patient's bite and improve alignment between the upper and lower jaws.

Manufacturing techniques such as direct fabrication allow for new occlusal block shapes and support structures to be formed as compared to traditional thermoformed aligners of the blocks. The occlusal block 110 includes an infill structure 102 that adds stiffness to the occlusal block. In a traditional thermoformed occlusal block stiffness may be provided only by the sidewalls of the occlusal block, whereas as depicted in FIG. 1A, and infill 102 which may be a cellular structure formed from cavities 112 separated by walls 114. The cellular structure 102 including the walls 114 may provide additional stiffness and support to aid in preventing the crushing of an occlusal block during normal aligner where such as when the patient bites down on their aligners. The cellular structure 102 may include cells or cavities 112 having a rectangular cross-section. In some embodiments other shapes may be employed such as square, honeycomb, etc.

In some embodiments, the occlusal block may include an infill structure configured to balance stiffness, weight, and flexibility through a variety of cellular or lattice geometries. The infill may take the form of a hexagonal honeycomb arrangement that distributes stress and provides a high stiffness-to-weight ratio, or a triangular or tetrahedral lattice that offers resistance to both compressive and shear forces. In some embodiments, the infill may include triply periodic minimal surface (TPMS) structures, such as gyroid, diamond, or Schwarz-P lattices, or other continuous, interconnected surfaces that absorb energy efficiently while minimizing material usage.

In some embodiments, the cellular structure may also be formed as a cross-hatched or orthogonal grid pattern in which intersecting walls provide load transmission from the occlusal surface to the base of the block. In some embodiments, a randomized or semi-random network of walls, such as a Voronoi network, may be. Other configurations may include pyramidal or conical cavities arranged to deform progressively under occlusal load, micro-beam or strut-based frameworks having circular or triangular cross-sections, or woven and interlocking rib networks such as basket-weave or crisscross arrangements may be used.

In some examples, the infill may have a gradient density in which smaller or denser cells are located near the occlusal surface to resist bite forces, while larger or less dense cells are positioned near the sidewalls to improve flexibility and comfort. The infill walls may be formed from the same polymeric material as the appliance or from a stiffer material selected to increase load-bearing capacity, and may be oriented along the occlusal-gingival direction, or along principal stress directions determined through computational modeling or finite element analysis.

Infill structures may be formed using additive manufacturing, multi-material printing.

FIG. 1B depicts a buccal-lingual cross section of a tooth receiving cavity 170 of an aligner 150. Tooth receiving cavity 170 may be defined by one or more side walls 172 and an occlusal surface 174. The occlusal surface 174 of the tooth receiving cavity 170 extends into the occlusal block 160. Manufacturing techniques such as direct fabrication allow for new occlusal block shapes and support structures to be formed as compared to traditional thermoformed aligners of the blocks. For example, occlusal block 160 includes sidewalls 176 that have a thickness that is different than the thickness of the sidewalls of the tooth receiving cavity 172. For example, as shown in FIG. 1B, the sidewalls 176 of the occlusal block 160 have a thickness that is greater than the sidewalls 172 of the tooth receiving cavity 170. The sidewalls 176 may have a thickness, as measured in the buccal lingual direction, that is at least 50% greater than the thickness of the sidewalls of the tooth receiving cavity, as measured in a buccal-lingual direction. In some embodiments, the thickness of the sidewalls of the tooth receiving cavity may be at least twice, at least three times, or at least five times thicker than the thickness of the sidewalls of the tooth receiving cavity. The increased thickness of the sidewalls allows for increased distribution of occlusal forces from the sidewall on to the occlusal surfaces of the teeth at a location 180 where the sidewalls contact the occlusal surface of the tooth.

The shape of the occlusal surface 174 of the tooth receiving cavity that protrudes into the occlusal block may include occlusally extending sidewalls 166, buccal-lingually extending occlusal wall 164, and a chamfer wall 168 that extends diagonally between the sidewalls and the occlusal. The combination of the solid occlusal block sidewalls of the occlusal surface along with the extension of the tooth receiving cavity into the occlusal block allows for increased stiffness of the occlusal block while providing for easy cleaning.

FIG. 2A depicts a system 200 of aligners 210, 220. The aligners 210, 220 may be 3D printed or directly fabricated aligners. In a 3D printing or additive manufacturing process, layers of material, such as polymer, are deposited one on another. Each layer is laid down and hardened or cured. As each new layer is added, it bonds to the layer below it. The layer-by-layer process continues until all layers are deposited, resulting in a 3D printed appliance and/or blocks. This layer-by-layer approach allows for the creation of complex structures and shapes that would be difficult or impossible to make with traditional manufacturing methods. The system 200 includes a lower aligner 220 with tooth receiving cavities for moving the teeth of the lower arch from a first arrangement towards a second arrangement and an upper aligner 210 with tooth receiving cavities for moving the teeth of the upper arch from a first arrangement towards a second arrangement. The aligners 210, 220 include respective occlusal blocks 212, 222 that extend from the respective occlusal surfaces of the upper arch and lower arch of the patient's dentition. As discussed above, occlusal blocks are features that may be incorporated into orthodontic aligners to facilitate mandibular advancement. Occlusal blocks may extend from the occlusal surfaces of the aligners, such as from the occlusal surfaces of the molars and premolars. Occlusal blocks can be located on an upper aligner, lower aligner, or both, depending on the patient's malocclusion and the treatment plan. Occlusal blocks create an elevated platform that extends the occlusal surface of an aligner in an occlusal direction to alter the natural bite of the patient when the aligners are worn. The design and thickness of occlusal blocks are customized to each patient's needs to effect mandibular advancement.

A pair of occlusal blocks, each on a respective aligner of opposing jaws, may form a twin-block system, which may be used to reposition the mandible of a patient.

When the patient wearing aligners 210, 220 having occlusal blocks 212, 222 closes their mouth, the occlusal blocks on the upper and lower aligners interact in a way that encourages the lower jaw to move forward, such as through contact of respective engagement surfaces 214, 224 on the occlusal blocks 210, 220. In some embodiments, the engagement surfaces 214, 224 may be referred to as appliance engagement region of the occlusal block as these surfaces engage with each other to move the patient's jaw. As shown in FIG. 2A, the occlusal blocks may have distinct shapes that do not match each other. The occlusal blocks 214, 224 are arranged relative to each other such that a patient wearing the aligners 210, 220 may not close their jaw in their natural occlusion. Instead, when the patient closes their jaws, the occlusal surfaces 216, 226 of the occlusal blocks may contact each other. A patient would shift their lower jaw relative to the upper jaw to slide the occlusal surfaces 216, 226 past each other allowing the patient to move their upper and lower arches into closer occlusion blocks and engaging the engagement surfaces 214, 224 against each other in order to hold the patient's lower jaw and upper jaw in an updated or corrected mesial distal arrangement. Over a series of stages of mandibular adjustment, the interaction of the occlusal blocks adjusts the relationship between the upper and lower jaw and over time causes changes in the patient's anatomy so that over time the aligners gradually reposition the natural location of the mandible into a more forward position to correct the patient's bite and improve alignment between the upper and lower jaws. In some embodiments, the engagement surfaces 214, 224 may be angled, such as with a slope extending in a mesial-distal direction, to allow the arches to open and close relative to each other and to provide mandibular repositioning forces to the upper and lower jaws.

Some occlusal blocks may have a flat base that is not contoured to fit the teeth over which the occlusal block is placed. However such occlusal blocks may not be properly supported by the teeth may extend over and may preclude adding aligner features such as aligner auxiliaries including attachments, attachment receiving cavities, buttons, and other aligner features in areas where traditional occlusal blocks may be placed or on teeth near where occlusal blocks are placed.

The occlusal blocks 212, 222 include features such as a lower surface that matches the contour of the occlusal and interproximal surfaces of the patient's dentition to provide additional support to the occlusal block and also improve engagement between the aligner at the locations of the occlusal block and the corresponding teeth. When the lower surface matches the contours of the occlusal and/or interproximal surfaces of the patient's dentition, the aligner may be retained on the teeth with greater retention forces allowing for improved orthodontic tooth movement, and also allowing for placement of aligner auxiliaries and other aligner features in closer proximity to the occlusal block, such as on the same teeth or tooth receiving cavities on which the occlusal block is located.

The lower surface 228 of the occlusal block 222 is shown shaped to match the occlusal surfaces of the teeth 202 over which the occlusal block 222 extends. In some embodiments, the shape of the lower surface 228 may be based on the shape of a 3D model of the patient's teeth form, for example, from an intraoral scan of the patient's dentition. In some embodiments, the shape of the lower surface of the occlusal block may have an offset from the shape of the patient's dentition such as an offset of between 10 microns and 250 microns. In some embodiments, a lower surface 228 may be shaped to match a first occlusal surface or surfaces of a first posterior tooth or teeth of the patient. In some embodiments, a lower surface 228 may also be shaped to match a second occlusal surface or surfaces of a second posterior tooth or teeth of the patient.

In some embodiments, the lower surface of the occlusal block may be defined in relation to a digital three-dimensional (3D) model of the patient's teeth, such as that derived from intraoral scanning or digital impression data. In some embodiments, the lower surface may not coincide exactly with the modeled tooth geometry but may instead be offset relative to the tooth surface to provide a predetermined space, compression, or directional contact pattern that induces controlled tooth movement. The offset may vary in magnitude or direction along the mesial-distal, buccal-lingual, or occlusal-gingival axes depending on the desired orthodontic movement for the underlying teeth.

For example, a buccal or lingual offset may be introduced to guide the tooth in the corresponding direction, while differential offsets across the surface may produce a torqueing or tipping moment about the tooth's long axis. The offset geometry may be determined using orthodontic treatment planning software that calculates a path of movement between a current and a target tooth position, such that the lower surface of the occlusal block is shaped to generate tooth movement forces when the appliance is worn. By incorporating such offset-based design, the occlusal block can simultaneously function as a stabilizing and force-delivering structure, promoting planned tooth movement in addition to jaw movement.

In some embodiments, the lower surface 228 of the occlusal block 222 may include protrusions 230 that extend between two adjacent teeth 202. For example, the protrusion 230 extends into the interproximal gap 232 between two adjacent teeth 202. In some embodiments, the protrusion may extend less than 2 mm into the interproximal area between adjacent teeth. In some embodiments, the interproximal gap 232 between a patient's teeth may be wide at an occlusal location and narrow towards the gingiva before widening again. In some embodiments, the protrusion 230 may be shaped such that it does not extend past the narrowest portion of the interproximal gap 232. In some embodiments, the protrusion may be shaped such that does not extend past an undercut of the patient's teeth in order to facilitate application of the aligner onto the patient's teeth. In some embodiments, a gingival most portion of the protrusion 230 may be shaped with a minimum radius. The minimum radius may determine the maximum depth the protrusion may protrude into the interproximal space. For example, a minimum radius of 0.5 mm may result in the protrusion not extending into a gap that is less than a 1 mm wide.

The right side of FIG. 2A a depicts a buccal lingual cross section of the tooth 202 and the aligner 220 with occlusal block 222. The lower surface 228 of the occlusal block 222 may match the buccal lingual contours of the patient's tooth 220. The tooth 202 includes buccal and lingual cusps 204 separated by a groove 206. The bottom surface of the occlusal block 222 may include a corresponding protrusion 236, which may be a convex surface, between two valleys 234 which may be concave surface features. The convex and concave surface features may also have minimum radius of curvature. The minimum radius is of curvature of the occlusal surface features may be less than the minimum radius of curvature of the interproximal surface features.

The occlusal blocks 212, 222 may include one or more transition zones 218A, 218B between the occlusal block and the sidewalls and occlusal surface walls of tooth receiving cavities. Transition zones may be locations on the orthodontic appliance where the thickness of the appliance material transitions from the relatively high thickness of the occlusal block to the relatively low wall thickness of the tooth receiving cavities. A transition zone 218 may be located on the mesial and of the occlusal block and/or the distal and of the occlusal block. For example, transition zone 218A is located mesially of the engagement surface of the occlusal block 212 and transition zone 218 the is located distally of the distal surface of the occlusal block 212. Occlusal block 222 may similarly include a transition zone located mesially of the mesial surface and distally of the engagement surface. The transition zone 218 aids in reducing stress concentrations that may be formed between the occlusal block and the tooth receiving cavity walls. The transition zone may include a variation in thickness along the zone starting at a thickness of the wall thickness of the tooth receiving cavity and gradually over a distance such as 1 mm or 2 mm increase towards the occlusal block such that when it reaches the engagement surface, mesial surface, or distal surface of the tooth receiving cavity the thickness may be two and four times thicker than the thickness of the wall of the tooth receiving cavity, such as between 0.3 and 1.5 mm.

In some embodiments, the transition zones may include gradual or compound curvature regions configured to distribute stress between the occlusal block and the adjacent tooth receiving cavity walls. Rather than a discrete step in thickness, the transition zone may define a smooth, contoured surface that blends the geometry of the occlusal block with that of the cavity wall. This gradual change in cross-sectional thickness may reduce localized strain and mitigate the risk of cracking, delamination, or fatigue failure during cyclic occlusal loading. The contour of the transition zone may be based on the expected stress distribution, such that the curvature radius or taper angle varies along the mesial-distal or buccal-lingual directions to accommodate localized variations in load transfer between the occlusal block and the underlying tooth surface.

In some embodiments, the transition zones may include material or stiffness gradients in addition to or rather than purely geometric transitions. For example, in additively manufactured or multi-material appliances, the polymer composition in the transition zone may vary gradually from a softer or more flexible material adjacent the tooth cavity to a stiffer material within the occlusal block. The stiffness gradient may have varying infill density, polymer cross-linking, or material formulation across the transition region.

In some embodiments, transition zones may include reinforcing ribs, fillets, or localized thickened regions arranged to resist unwanted deformation while maintaining smooth mechanical behavior under load.

Transition zones may be generated algorithmically within a digital treatment design workflow. A 3D model of the appliance may be processed to automatically define boundary regions between the occlusal block and the tooth receiving cavities, where a thickness gradient is applied according to predetermined design parameters. For example, the software may specify a taper ratio, radius of curvature, or gradient profile along each transition zone based on the mechanical requirements of the treatment stage or the material properties of the aligner.

Some occlusal blocks may have a flat upper or occlusal (e.g., top surfaces of blocks on the lower jaw and bottom surfaces for blocks on the upper arch) that is not contoured to fit the occlusal surfaces of the teeth or aligner of the opposing arch. However such occlusal blocks may not be properly supported by the teeth they may occlude with and may not engage with the teeth, allowing the blocks to slide and move over the occlusal surfaces of the opposing arch, may preclude adding aligner features such as aligner exhilaration including attachments, attachment receiving cavities, buttons, and other aligner features in areas where traditional occlusal blocks may be placed or on teeth near where occlusal blocks are placed.

In FIG. 2B, the occlusal blocks 212, 222 include features such as respective upper surfaces 216, 226 may include an intercuspal region that matches the contour of the occlusal and/or interproximal surfaces of the teeth or aligner of the opposing arch to provide additional engagement of the occlusal block with the opposing arch. When the upper surface matches the contours of the occlusal and/or interproximal surfaces of the opposing arch, the blocks may aid in limiting side-to-side and mesial-distal sliding of the arches relative to each other. In some embodiments, the upper surfaces 216, 226 may match a region of the opposing occlusal surfaces that is adjacent the opposing appliance's engagement surface, such as immediately adjacent.

The upper surface 226 of the occlusal block 222 is shown shaped to match the occlusal surfaces of the aligner 210 of the opposing arch. In some embodiments, the shape of the upper surface 226 may be based on the shape of a 3D model of the patient's teeth form, for example, an intraoral scan of the patient's dentition or a 3D model of the occlusal surface of the aligner 210 on an opposing arch. In some embodiments, the shape of the upper surface of the occlusal block may have an offset from the shape of the patient's opposing dentition or aligner, such as an offset of between 10 microns and 250 microns, between 50 and 250 microns, or between 100 microns and 250 microns.

In some embodiments, the upper surface 228 of the occlusal block 222 may include protrusions 250 that extends between two adjacent tooth receiving cavities of the opposing aligner or between teeth 202. For example, the protrusion 250 extends into the interproximal location of the aligner between two adjacent tooth receiving cavities 202. In some embodiments, the protrusion may extend less than 2 mm into the interproximal area. In some embodiments, a occlusal most portion of the protrusion 250 (e.g., the portion that extends into the interproximal area the most) may be shaped with a minimum radius. The minimum radius may determine the maximum depth the protrusion may protrude into the interproximal space. For example, a minimum radius of 0.5 mm may result in the protrusion not extending into a gap that is less than a 1 mm wide.

The right side of FIG. 2B depicts a buccal lingual cross section of the tooth 202 and the aligner 220 with occlusal block 222. The upper surface 228 of the occlusal block 222 may match the buccal lingual contours of the opposing tooth or tooth receiving cavity of the appliance 210 on an opposing arch of the patient. The opposing appliance 210 includes buccal and lingual cusps 254 separated by a groove 256. The upper surface of the occlusal block 222 may include a corresponding protrusion 246, which may be a convex surface, between two valleys 244 which may be concave surface features. The convex and concave surface features may also have minimum radius is of curvature. The minimum radius is of curvature of the occlusal surface features may be less than the minimum radius of curvature of the interproximal surface features.

The lower surface 228 of the occlusal block 222 may match the buccal lingual contours of the patient's tooth 220. The tooth 202 includes buccal and lingual cusps 204 separated by a groove 206. The bottom surface of the occlusal block 222 may include a corresponding protrusion 236, which may be a convex surface, between two valleys 234 which may be concave surface features. The convex and concave surface features may also have minimum radius is of curvature. The minimum radius is of curvature of the occlusal surface features may be less than the minimum radius of curvature of the interproximal surface features.

Returning to the left side of FIG. 2B, the occlusal blocks 212, 222 include features such as a lower surface that matches the contour of the occlusal and interproximal surfaces of the patient's dentition to provide additional support to the occlusal block and also improve engagement between the aligner at the locations of the occlusal block and the corresponding teeth. When the lower surface matches the contours of the occlusal and/or interproximal surfaces of the patient's dentition, the aligner may be retained on the teeth with greater retention forces allowing for improved orthodontic tooth movement, and also allowing for placement of aligner auxiliaries and other aligner features in closer proximity to the occlusal block, such as on the same teeth or tooth receiving cavities on which the occlusal block is located.

The lower surface 228 of the occlusal block 222 is shown shaped to match the occlusal surfaces of the teeth 202 over which the occlusal block 222 extends. In some embodiments, the shape of the lower surface 228 may be based on the shape of a 3D model of the patient's teeth form, for example, from an intraoral scan of the patient's dentition. In some embodiments, the shape of the lower surface of the occlusal block may have an offset from the shape of the patient's dentition such as an offset of between 10 microns and 250 microns.

In some embodiments, the lower surface 228 of the occlusal block 222 may include protrusions 230 that extend between two adjacent teeth 202. The protrusions 230 may comprise an infill region that extends into the interproximal area between two teeth on which the block is located. For example, the protrusion 230 extends into the interproximal gap 232 between two adjacent teeth 202. In some embodiments, the protrusion may extend less than 2 mm into the interproximal area between adjacent teeth. In some embodiments, the interproximal gap 232 between a patient's teeth may be wide at an occlusal location and narrow towards the gingiva before widening again. In some embodiments, the protrusion 230 may be shaped such that it does not extend past the narrowest portion of the interproximal gap 232. In some embodiments, the protrusion may be shaped such that does not extend past an undercut of the patient's teeth in order to facilitate application of the aligner onto the patient's teeth. In some embodiments, a gingival most portion of the protrusion 230 may be shaped with a minimum radius. The minimum radius may determine the maximum depth the protrusion may protrude into the interproximal space. For example, a minimum radius of 0.5 mm may result in the protrusion not extending into a gap that is less than a 1 mm wide.

The occlusal blocks 212, 222 may include one or more transition zones 218A, 218B between the occlusal block and the sidewalls and occlusal surface walls of tooth receiving cavities. Our locations on the orthodontic appliance where the thickness of the appliance material transitions from the relatively high thickness of the occlusal block to the relatively low wall thickness of the tooth receiving cavities. A transition zone 218 may be located on the mesial and of the occlusal block and/or the distal and of the occlusal block. For example, transition zone 218A is located mesially of the engagement surface of the occlusal block 212 and transition zone 218 the is located distally of the distal surface of the occlusal block 212. Occlusal block 222 may similarly include a transition zone located mesially of the mesial surface and distally of the engagement surface. The transition zone 218 aids in reducing stress concentrations that may be formed between the occlusal block and the tooth receiving cavity walls. The transition zone may include a variation in thickness along the zone starting at a thickness of the wall thickness of the tooth receiving cavity and gradually over a distance such as 1 mm or 2 mm increase towards the occlusal block such that when it reaches the engagement surface, mesial surface, or distal surface of the tooth receiving cavity the thickness may be two and four times thicker than the thickness of the wall of the tooth receiving cavity, such as between 0.3 and 1.5 mm.

FIG. 2C depicts a system 200 of aligners 210, 220. The system 200 includes a lower aligner 220 with tooth receiving cavities for moving the teeth of the lower arch from a first arrangement towards a second arrangement and an upper aligner 210 with tooth receiving cavities for moving the teeth of the upper arch from a first arrangement towards a second arrangement. The aligners 210, 220 include respective occlusal blocks 212, 222 that extend from the respective occlusal surfaces of the upper arch and lower arch of the patient's dentition. As discussed above, occlusal blocks are features that may be incorporated into orthodontic aligners to facilitate mandibular advancement. Occlusal blocks may extend from the occlusal surfaces of the aligners, such as from the occlusal surfaces of the molars and premolars. Occlusal blocks can be located on an upper aligner, lower aligner, or both, depending on the patient's malocclusion and the treatment plan. Occlusal blocks create an elevated platform that extends the occlusal surface of an aligner in an occlusal direction to alter the natural bite of the patient when the aligners are worn. The design and thickness of occlusal blocks are customized to each patient's needs to effect mandibular advancement.

The system 200 includes all of the features of the system 200 of FIG. 2B with like numbers representing similar features. However, the upper and lower arches are in closer occlusion. Thus the occlusal blocks of FIG. 2C have a lower overall height. In addition, the occlusal upper surface 216 of the occlusal block 212 includes a second protrusion that extends into the interproximal area of the aligner 220 on the lower arch.

The right side of FIG. 2C a depicts a buccal lingual cross section of the tooth 202 and the aligner 220 with occlusal block 222. The buccal and lingual sides 258 of the upper surface of the occlusal block 222 extends over respective buccal and lingual sides of the tooth and/or aligner 210 of the opposing arch. The buccal and lingual sides 258 may include protrusions that extend beyond the occlusal surface of the tooth or aligner with which it engages.

In some embodiments, a pair of appliances, such as an upper aligner and a lower aligner, may include respective occlusal blocks having occlusal surfaces with differing conformity to the opposing arch. For example, the occlusal surfaces of the occlusal blocks on a first arch, such as the lower arch, may be contoured, as described above, for example, to match the opposing teeth or aligner, while the occlusal surfaces of the occlusal blocks on a second arch, such as the upper arch, may not conform, such that they may be may be generally flat, or only partially conforming. The differing conformity between the two arches may allow the occlusal blocks to slide relative to each other when the patient closes the jaws into occlusion. This sliding interaction may facilitate natural mandibular motion during mastication or speech and may reduce binding or locking of the blocks when the arches move laterally or in protrusion and retrusion.

The non-conforming occlusal surface of the occlusal block may be planar, slightly convex, or defined by a smooth curvature that contacts only the apices of the opposing occlusal features. In contrast, the conforming occlusal surface on the opposing arch may include intercuspal and interproximal features that follow the contours of the patient's dentition or aligner, providing stable vertical support and guidance for the opposing blocks.

In some embodiments, the degree of conformity between the opposing occlusal blocks may be selected based on the desired functional outcome. The use of different levels of occlusal conformity between upper and lower appliances thus enables customized control of mandibular dynamics while maintaining occlusal stability and patient comfort.

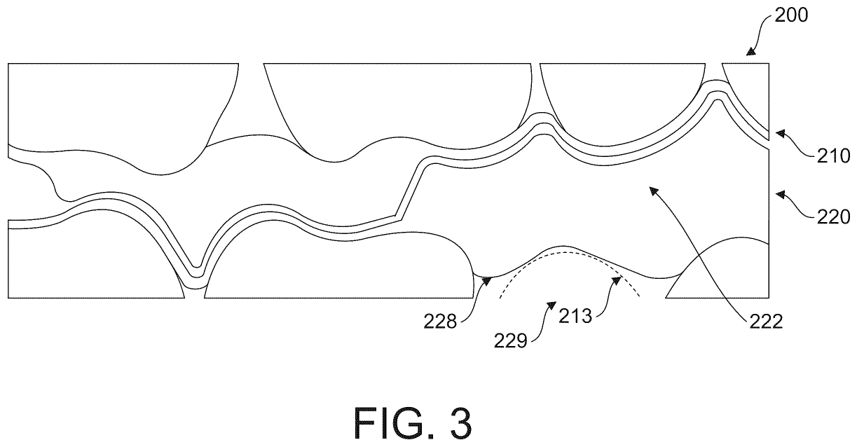

FIG. 3 depicts a system 200 of aligners 210, 220. The system 200 includes a lower aligner 220 with tooth receiving cavities for moving the teeth of the lower arch from a first arrangement towards a second arrangement and an upper aligner 210 with tooth receiving cavities for moving the teeth of the upper arch from a first arrangement towards a second arrangement. The aligners 210, 220 include respective occlusal blocks 212, 222 that extend from the respective occlusal surfaces of the upper arch and lower arch of the patient's dentition. As discussed above, occlusal blocks are features that may be incorporated into orthodontic aligners to facilitate mandibular advancement. Occlusal blocks may extend from the occlusal surfaces of the aligners, such as from the occlusal surfaces of the molars and premolars. Occlusal blocks can be located on an upper aligner, lower aligner, or both, depending on the patient's malocclusion and the treatment plan. Occlusal blocks create an elevated platform that extends the occlusal surface of an aligner in an occlusal direction to alter the natural bite of the patient when the aligners are worn. The design and thickness of occlusal blocks are customized to each patient's needs to effect mandibular advancement.

The system 200 may include some or all of the features of the system 200 of FIG. 2B with like numbers representing similar features and may omit numbers for clarity. However, the lower surface 228 of the occlusal block 222 spans a gap 229 for a missing or erupting tooth. The lower surface 228 of the occlusal block 222 may have a contour that matches the occlusal surface shape 213 of the missing or erupting tooth. In some embodiments, the gap may be filled by a crown or tooth implant or other prosthetic. In some embodiments the contour 213 may match the surface shape of the crown, tooth implant, or other prosthetic. In some embodiments the contour 213 may match the surface shape and expected location or planned location of an erupting tooth or of a crown, tooth implant, or other prosthetic.

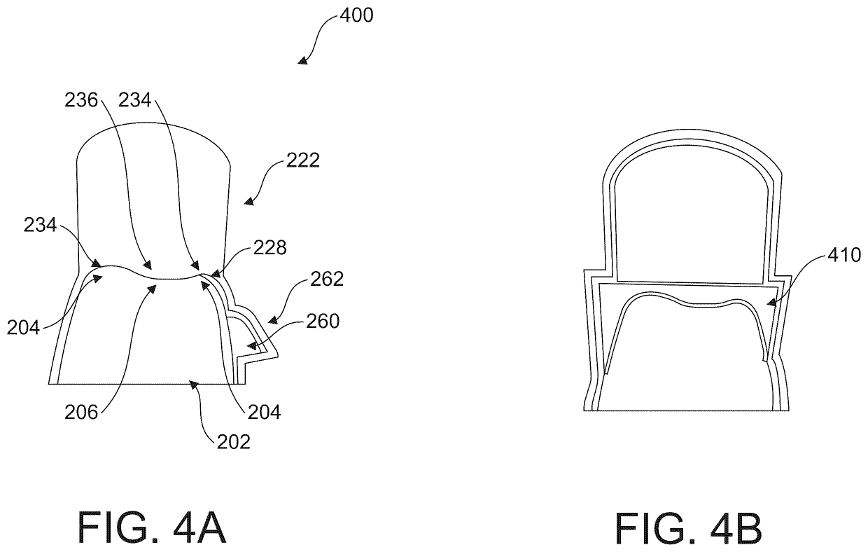

FIG. 4A depicts a buccal-lingual cross section of an aligner 400 on a tooth 202 and having an occlusal block 222. The aligner 400 may have some or all of the features of the aligners discussed herein. Direct fabrication of aligners provides for better occlusal coverage than traditional thermoformed aligners with occlusal support blocks inserted into an occlusal block cavity, such as depicted in FIG. 4B, which includes a clearance zone 410 for insertion of occlusal blocks. Especially with narrow teeth, traditional method can leave gap between block and teeth and reduce tooth coverage. The clearance zone, being unsupported by the tooth allows for deformation of the aligner and may prevent the application of tooth moving forces on the tooth.

Orthodontic appliances function by applying force to specific surfaces of the teeth or dental features to cause directed movement. However, the type of movement and level of force applied is usually dependent on the surface characteristics and positions of the dental features. In many cases, the native tooth surface(s) and other dental features of a patient are inadequate to provide sufficient anchoring or to impart sufficient force on the teeth to be repositioned. To overcome these limitations, one or more attachment devices which may be attached to preselected attachment points on the teeth or dental features to provide the appropriate physical leverage. Specific design and location of these attachment devices may be determined based on the movements of the treatment plan and may provide greater repositioning forces, anchoring ability, and appliance retention as compared to a tooth without an attachment, such as the ability to extrude, rotate, and otherwise manipulate teeth.

Attachment devices may be bonded to the surface of the teeth in order to provide physical features which facilitate the application of controlled force. The attachment devices may be fixedly attached to the surface of a tooth or other dental feature in order to transmit force generated by the dental positioning appliance to the dental feature and/or to anchor the positioning appliance to teeth in order to permit the appliance to apply forces elsewhere in the patient's teeth. In such embodiments, the attachment device may act to assist in the transmission of force between the teeth and the dental positioning appliance.

Referring back to FIG. 4A, the increased engagement and occlusal contact with directly fabricated aligners facilitates increased engagement between the aligner and the tooth. For example, the lower surface 228 of the occlusal block 222 may match the contours of the patient's tooth 202. The tooth 202 includes buccal and lingual cusps 204 separated by a groove 206. The bottom surface of the occlusal block 222 may include a corresponding protrusion 236, which may be a convex surface, between two valleys 234 which may be concave surface features. The convex and concave surface features may also have minimum radius is of curvature. The minimum radius is of curvature of the occlusal surface features may be less than the minimum radius of curvature of the interproximal surface features. By following the contours of the tooth surface the aligner can engage those surfaces allows for force transfer between the occlusal block (and thus the aligner) and the tooth. Such engagement particularly allows buccal-lingual forces and mesial-distal forces to transfer between the aligner and the tooth. The increased engagement and lack of a gap between the aligner and the tooth that would otherwise exist due to the clearance zone, allows for the use of attachments 260 on the tooth and tooth receiving cavities 262 to receive and engage the tooth receiving cavity.

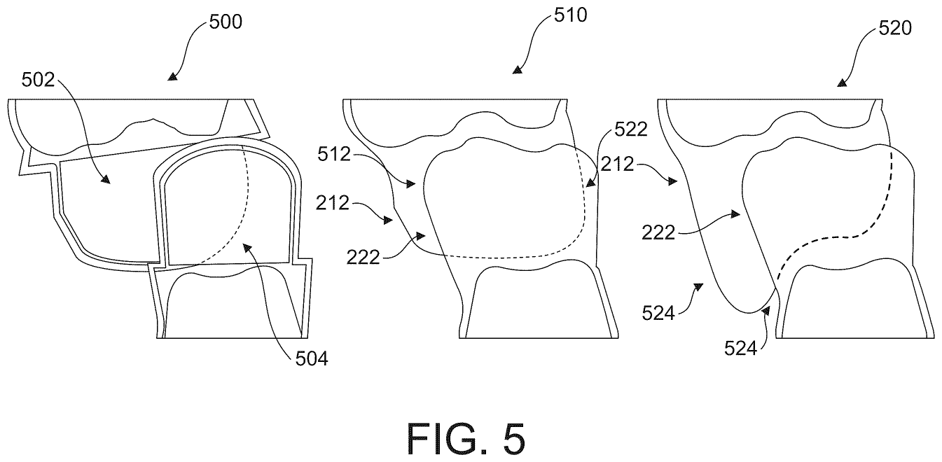

FIG. 5 depicts three embodiments of aligners with occlusal blocks for use when upper and lower arches and not aligned in a buccal-lingual direction, such as when a patient's dentition has a crossbite malocclusion. In the embodiments, such as those shown in FIG. 5, the tooth of the upper arch is displaced laterally (e.g., buccally or lingually along the buccal-lingual axis) with respect to the lower arch, such that the upper and lower teeth do not come into proper occlusion. When traditional aligners with generic occlusal blocks are applied, the blocks do not overlap as much as desired. The lack of proper overlap can cause the blocks to slip past each other, moving the patient's jaw further out of alignment, and can cause reduced stability of the jaws when in occlusion, and other issues.

The left most system 500 in FIG. 5 shows an aligner with clearance zones for inserting generic occlusal block support so then an occlusal block receiving cavity of an aligner. The occlusal blocks 502, 504, having a predetermined shape, are mounted within the aligner over the tooth receiving cavity. Such a process results in little overlap between the occlusal block 504, 502 when the patient's arches are brought into occlusion.

The system 510 depicted in the center of FIG. 5 depicts patient specific 3D printed aligners with integrated occlusal blocks 212, 222. The occlusal blocks 212, 222 may have features similar to the occlusal blocks 212, 222 discussed throughout this disclosure. The teeth and associated arches on which the appliances of system 510 are applied are offset in the buccal-lingual direction. In order to provide the desired engagement between occlusal block 212 an occlusal block 222, the buccal and lingual sides of the occlusal blocks have been extended beyond the buccal and lingual sides of the tooth over which the occlusal blocks are placed when the aligner is worn by the patient. For example, occlusal block 212 includes a buccal extension 522 that extends beyond the buccal side of the patient's tooth on which the occlusal block 212 is located when the aligner is worn by the patient. Similarly, occlusal block 222 includes a lingual intrusion or extension 512 that extends beyond the lingual side of the patient's tooth. The buccal and lingual extensions of the respective occlusal blocks allow for greater overlap and engagement of the engagement surfaces between the respective occlusal blocks. The greater engagement allows for increased ability and improve treatment as compared to the system 500, particularly when the teeth of the patient's upper and lower arch are not in a buccal lingual alignment.

The system 520 depicted on the right of FIG. 5 includes patient specific 3D printed aligners with integrated occlusal blocks 212, 222. The occlusal blocks 212, 222 may have features similar to the occlusal blocks 212, 222 discussed throughout this disclosure. The teeth and associated arches on which the appliances of system 520 applied are offset in the buccal-lingual direction. In order to provide the desired engagement between occlusal block 212 an occlusal block 222, the buccal and lingual sides of the occlusal blocks have been extended beyond the buccal and lingual sides of the tooth over which the occlusal blocks are placed when the aligner is worn by the patient. In addition, the occlusal block 512 includes an occlusal extension or protrusion 524 that extends beyond the occlusal plane of the tooth of the opposing arch on a lingual or buccal side of the tooth of the opposing arch. Such an extension 524 may include a surface 526 that faces the side of tooth of the opposing arch when the patient's arches are in occlusion. The extension 524 and the surface 526 may act against the opposing tooth in order to limit or prevent side to side movement of the patient's arches relative to each other. Limiting side to side movement of the patient's arches aid in preventing the occlusal blocks 212, 222 from slipping past each other and increases the engagement between the occlusal blocks, particularly as compared to system 500.

The greater engagement allows for increased ability and improve treatment as compared to the system 500, particularly when the teeth of the patient's upper and lower arch are not in a buccal lingual alignment.

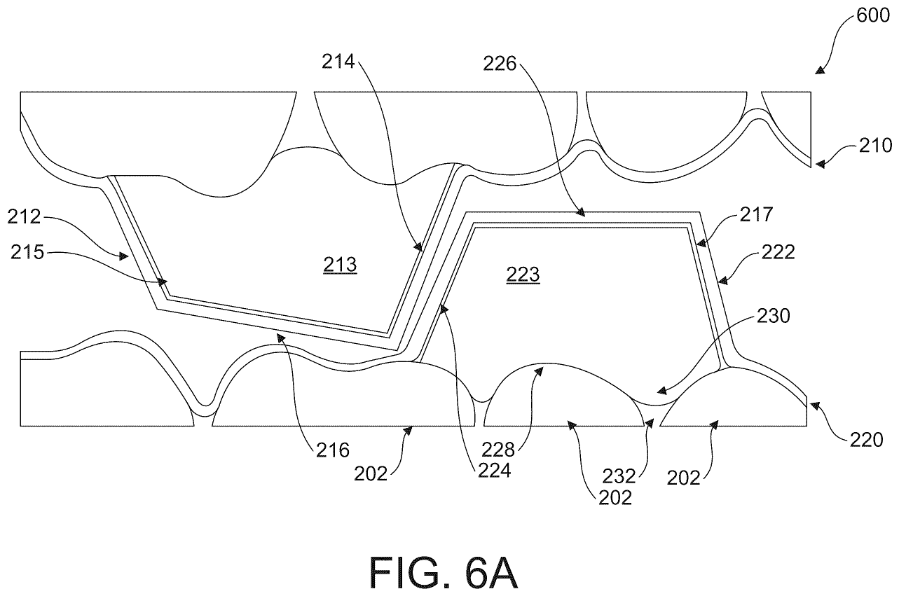

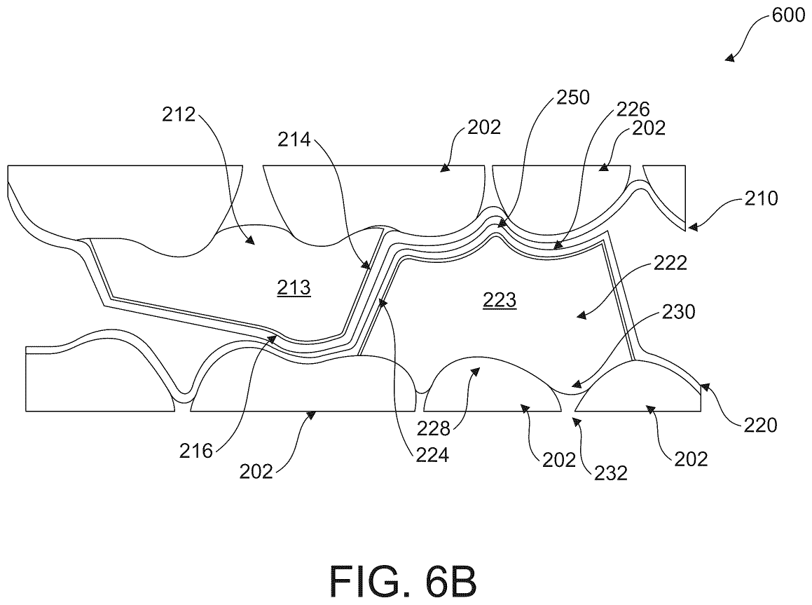

FIGS. 6A and 6B depict aligner system 600, 602 that include embodiments of hybrid occlusal block designs. With reference to FIG. 6A, the system 600 includes a lower aligner 220 with tooth receiving cavities for moving the teeth of the lower arch from a first arrangement towards a second arrangement and an upper aligner 210 with tooth receiving cavities for moving the teeth of the upper arch from a first arrangement towards a second arrangement. The aligners 210, 220 may be thermoformed polymeric shells or directly fabricated polymeric shells. The aligners 210, 220 include respective occlusal blocks 212, 222 that extend from the respective occlusal surfaces of the upper arch and lower arch of the patient's dentition. As discussed above, occlusal blocks are features that may be incorporated into orthodontic aligners to facilitate mandibular advancement. Occlusal blocks may extend from the occlusal surfaces of the aligners. The occlusal blocks 212, 222 are of a hybrid design wherein each of the of the occlusal blocks 212, 222 include occlusal block receiving cavities having 3D printed and patient specific occlusal block supports 213, 223 received therein.

The occlusal blocks supports 213, 223 include features such as a lower surface that matches the contour of the occlusal and interproximal surfaces of the patient's dentition to provide additional support to the occlusal block and also improve engagement between the aligner at the locations of the occlusal block and the corresponding teeth. When the lower surface matches the contours of the occlusal and/or interproximal surfaces of the patient's dentition, the aligner may be retained on the teeth with greater retention forces allowing for improved orthodontic tooth movement, and also allowing for placement of aligner auxiliaries and other aligner features in closer proximity to the occlusal block, such as on the same teeth or tooth receiving cavities on which the occlusal block is located. The occlusal blocks supports 213, 223 may be 3D printed or otherwise directly fabricated. In some embodiments, the occlusal block supports 213, 223 may be formed separate from the aligner 210, 220 and then coupled to a respective aligner via laser welding, ultrasonic welding, epoxy, adhesive, or other process or material or combination thereof. In some embodiments, the occlusal blocks my include integrally formed supports that are formed integrally with the aligner, such as depicted in FIGS. 2A and 2B. In some embodiments, the occlusal block supports may be directly fabricated into cavities 215, 217 shaped to receive the block supports therein.

The lower surface 228 of the occlusal block support 223 is shown shaped to match the occlusal surfaces of the teeth 202 over which the occlusal block support 223 extends. In some embodiments, the shape of the lower surface 228 may be based on the shape of a 3D model of the patient's teeth form, for example, from an intraoral scan of the patient's dentition. In some embodiments, the shape of the lower surface of the occlusal block may have an offset from the shape of the patient's dentition such as an offset of between 10 microns and 250 microns.

In some embodiments, the lower surface 228 of the occlusal block support 223 may include protrusions 230 that extend between two adjacent teeth 202. For example, the protrusion 230 extends into the interproximal gap 232 between two adjacent teeth 202. In some embodiments, the protrusion may extend less than 2 mm into the interproximal area between adjacent teeth. In some embodiments, the interproximal gap 232 between a patient's teeth may be wide at an occlusal location and narrow towards the gingiva before widening again. In some embodiments, the protrusion 230 may be shaped such that it does not extend past the narrowest portion of the interproximal gap 232. In some embodiments, the protrusion may be shaped such that does not extend past an undercut of the patient's teeth in order to facilitate application of the aligner onto the patient's teeth. In some embodiments, a gingival most portion of the protrusion 230 may be shaped with a minimum radius. The minimum radius may determine the maximum depth the protrusion may protrude into the interproximal space. For example, a minimum radius of 0.5 mm may result in the protrusion not extending into a gap that is less than a 1 mm wide.

With reference to FIG. 6B, the system 602 includes a lower aligner 220 with tooth receiving cavities for moving the teeth of the lower arch from a first arrangement towards a second arrangement and an upper aligner 210 with tooth receiving cavities for moving the teeth of the upper arch from a first arrangement towards a second arrangement. The aligners 210, 220 include respective occlusal blocks 212, 222 that extend from the respective occlusal surfaces of the upper arch and lower arch of the patient's dentition. As discussed above, occlusal blocks are features that may be incorporated into orthodontic aligners to facilitate mandibular advancement. Occlusal blocks may extend from the occlusal surfaces of the aligners. The occlusal blocks 212, 222 are of a hybrid design wherein each of the of the occlusal blocks 212, 222 include occlusal block receiving cavities having 3D printed and patient specific occlusal block supports 213, 223 received therein.

In FIG. 6B, the occlusal blocks 212, 222 include features such as respective upper surfaces 216, 226 that matches the contour of the occlusal and interproximal surfaces of the teeth or aligner of the opposing arch to provide additional engagement of the occlusal block with the opposing arch. When the upper surface matches the contours of the occlusal and/or interproximal surfaces of the opposing arch, the blocks may aid in limiting side-to-side and mesial-distal sliding of the arches relative to each other. The occlusal block support may include similar features that match the inner surface of the occlusal block receiving cavity. For example, the upper surface 226 of the occlusal block support is shown shaped to match the occlusal surfaces of the aligner 210 of the opposing arch. The inner surface of the occlusal block receiving cavity may have a similar shape and the occlusal block support 223 within the occlusal block receiving cavity may also have a corresponding shape to the shape of the inner surface thereby providing close contact engagement between the occlusal block support 223 and the aligner that forms the occlusal block 222.

The occlusal blocks supports 213, 223 include features such as a lower surface that matches the contour of the occlusal and interproximal surfaces of the patient's dentition to provide additional support to the occlusal block and also improve engagement between the aligner at the locations of the occlusal block and the corresponding teeth. When the lower surface matches the contours of the occlusal and/or interproximal surfaces of the patient's dentition, the aligner may be retained on the teeth with greater retention forces allowing for improved orthodontic tooth movement, and also allowing for placement of aligner auxiliaries and other aligner features in closer proximity to the occlusal block, such as on the same teeth or tooth receiving cavities on which the occlusal block is located.

The lower surface 228 of the occlusal block support 223 is shown shaped to match the occlusal surfaces of the teeth 202 over which the occlusal block support 223 extends. In some embodiments, the shape of the lower surface 228 may be based on the shape of a 3D model of the patient's teeth form, for example, from an intraoral scan of the patient's dentition. In some embodiments, the shape of the lower surface of the occlusal block may have an offset from the shape of the patient's dentition such as an offset of between 10 microns and 250 microns.

In some embodiments, the lower surface 228 of the occlusal block support 223 may include protrusions 230 that extend between two adjacent teeth 202. For example, the protrusion 230 extends into the interproximal gap 232 between two adjacent teeth 202. In some embodiments, the protrusion may extend less than 2 mm into the interproximal area between adjacent teeth. In some embodiments, the interproximal gap 232 between a patient's teeth may be wide at an occlusal location and narrow towards the gingiva before widening again. In some embodiments, the protrusion 230 may be shaped such that it does not extend past the narrowest portion of the interproximal gap 232. In some embodiments, the protrusion may be shaped such that does not extend past an undercut of the patient's teeth in order to facilitate application of the aligner onto the patient's teeth. In some embodiments, a gingival most portion of the protrusion 230 may be shaped with a minimum radius. The minimum radius may determine the maximum depth the protrusion may protrude into the interproximal space. For example, a minimum radius of 0.5 mm may result in the protrusion not extending into a gap that is less than a 1 mm wide.

The occlusal blocks may include one or more transition zones between the occlusal block and the sidewalls and occlusal surface walls of tooth receiving cavities. Transition zones may be locations on the orthodontic appliance where the thickness of the appliance material transitions from the relatively high thickness of the occlusal block to the relatively low wall thickness of the tooth receiving cavities. A transition zone may be located on the mesial and of the occlusal block and/or the distal and of the occlusal block. For example, transition zone is located mesially of the engagement surface of the occlusal block and transition zone the is located distally of the distal surface of the occlusal block. Occlusal block may similarly include a transition zone located mesially of the mesial surface and distally of the engagement surface. The transition zone aids in reducing stress concentrations that may be formed between the occlusal block and the tooth receiving cavity walls. The transition zone may include a variation in thickness along the zone starting at a thickness of the wall thickness of the tooth receiving cavity and gradually over a distance such as 1 mm or 2 mm increase towards the occlusal block such that when it reaches the engagement surface, mesial surface, or distal surface of the tooth receiving cavity the thickness may be two and four times thicker than the thickness of the wall of the tooth receiving cavity, such as between 0.3 and 1.5 mm.

In some embodiments, the transition zones may include gradual or compound curvature regions configured to distribute stress between the occlusal block and the adjacent tooth receiving cavity walls. Rather than a discrete step in thickness, the transition zone may define a smooth, contoured surface that blends the geometry of the occlusal block with that of the cavity wall. This gradual change in cross-sectional thickness may reduce localized strain and mitigate the risk of cracking, delamination, or fatigue failure during cyclic occlusal loading. The contour of the transition zone may be based on the expected stress distribution, such that the curvature radius or taper angle varies along the mesial-distal or buccal-lingual directions to accommodate localized variations in load transfer between the occlusal block and the underlying tooth surface.

In some embodiments, the transition zones may include material or stiffness gradients in addition to or rather than purely geometric transitions. For example, in additively manufactured or multi-material appliances, the polymer composition in the transition zone may vary gradually from a softer or more flexible material adjacent the tooth cavity to a stiffer material within the occlusal block. The stiffness gradient may have varying infill density, polymer cross-linking, or material formulation across the transition region.

In some embodiments, transition zones may include reinforcing ribs, fillets, or localized thickened regions arranged to resist unwanted deformation while maintaining smooth mechanical behavior under load.

Transition zones may be generated algorithmically within a digital treatment design workflow. A 3D model of the appliance may be processed to automatically define boundary regions between the occlusal block and the tooth receiving cavities, where a thickness gradient is applied according to predetermined design parameters. For example, the software may specify a taper ratio, radius of curvature, or gradient profile along each transition zone based on the mechanical requirements of the treatment stage or the material properties of the aligner.

In some embodiments, occlusal support blocks 213 and 223 may include transition zones that are formed integrally with the occlusal support blocks during fabrication to provide a smooth change in thickness between the occlusal support region and the adjacent aligner walls. Each transition zone may define a region in which the occlusal support block material gradually tapers from the relatively thicker occlusal support portion an end. The transition zones may be configured to reduce abrupt changes in material stiffness and to distribute stress uniformly along the boundary where the occlusal support block ends and the surrounding aligner structure begins to contact the teeth. The gradual shift in thickness and curvature within these zones enhances the mechanical durability of the occlusal support blocks and reduces the likelihood of cracking or delamination during cyclic occlusal loading.

The transition zones of occlusal support blocks 213 and 223 may be formed through digital modeling processes that define continuous curvature or reduction in thickness at the distal, mesial, buccal, and lingual base of the occlusal support block. In additive manufacturing processes, the transition region may be created by varying the layer thickness, infill density, or print exposure parameters to achieve a controlled gradient in stiffness and cross-sectional thickness.

In some embodiments, the transition zones of occlusal support blocks 213 and 223 may also include microstructural or material gradients. For example, a softer or more flexible material may be incorporated at the periphery of the occlusal support block, while the core region remains composed of a stiffer polymer. This material gradient may be achieved through, for example, multi-material printing, controlled variable resin mixing, or variable cross linking during fabrication.

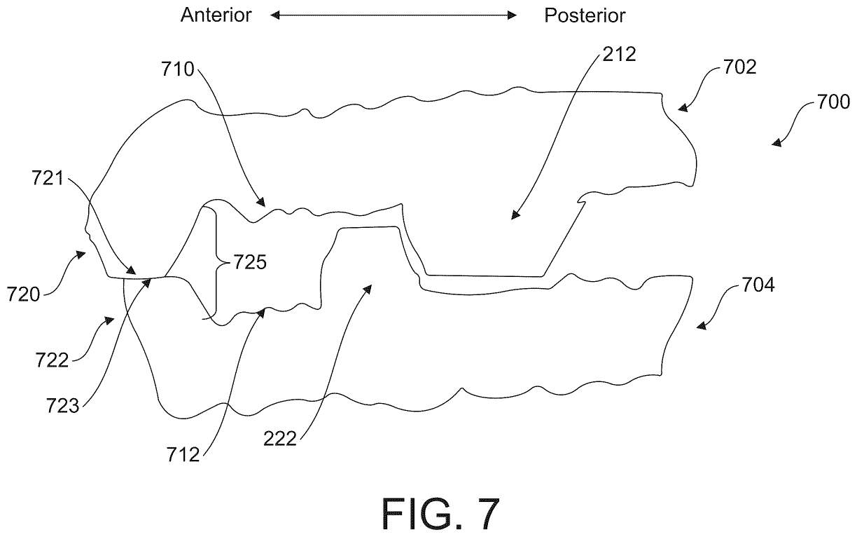

In some embodiments, the transition zones may be designed to follow the anatomical contours of the patient's dentition. The zones may extend along the mesial and distal ends of each occlusal support block and, in some configurations, may wrap partially along the buccal and lingual sides of the block to ensure a continuous and gradual integration with the aligner wall. The geometry of each transition zone may be customized within the digital treatment planning software based on the patient's occlusal anatomy, expected loading direction, and local wall thickness of the aligner. As a result, the occlusal support blocks 213 and 223 exhibit smooth mechanical transitions to adjacent aligner regions, improving both comfort and performance while ensuring durability throughout orthodontic treatment. FIG. 7 depicts an embodiment of a system of aligners 702, 704 which may have the features of the aligners discussed herein. Occlusal blocks used for mandibular advancement treatment may have a side effect of causing posterior open bite. Posterior open bite may be a result of occlusal pressure on the occlusal blocks which may be transferred to the teeth where the blocks are located. Intrusion of these teeth may result in lack of occlusion after mandibular advancement is complete. Aligners 702, 704 include occlusal blocks 212, 222 which may have some or all of the features of the occlusal blocks discussed herein. In addition, the aligners 702, 704 may include one or more anterior blocks 720, 722 over anterior teeth. The anterior blocks or extensions 720, 722, extend from the occlusal portion 710, 712 of the aligners 702, 704, such as beyond an occlusal plane of the aligners from which they extend. The anterior blocks 720, 722 may have all the features of the occlusal blocks discussed herein, but located an anterior teeth rather than posterior teeth.

The anterior blocks 720, 722 may include respective occlusal contact surfaces 721, 723. The occlusal contact surfaces may aid in distributing the occlusal forces imparted by the patient's jaws onto the teeth. The distribution of the occlusal forces may reduce the occlusal forces on the posterior teeth to aid in reducing or eliminating unwanted intrusion of the patient's posterior teeth. In some embodiments, if the forces on the posterior teeth because intrusion, the forces caused by the anterior blocks may cause similar intrusion of the anterior teeth. When both the posterior and anterior teeth intrude, severe posterior open bite may be prevented because anterior and posterior teeth intrude together. In some embodiments, a gap 725 may be designed between the anterior portion of the occlusal services of the patient's upper and lower arches during treatment planning. The anterior blocks may each extend about half of the distance 725. In some embodiments, the anterior blocks 720, 722 combine to extend for the distance 725. In some embodiments, each of the interior block 720, 722 extend between 40% and 60% of the distance 725. In some embodiments a single anterior block 720 or 722 may extend the distance 725 to the occlusal surface of the opposing aligner.

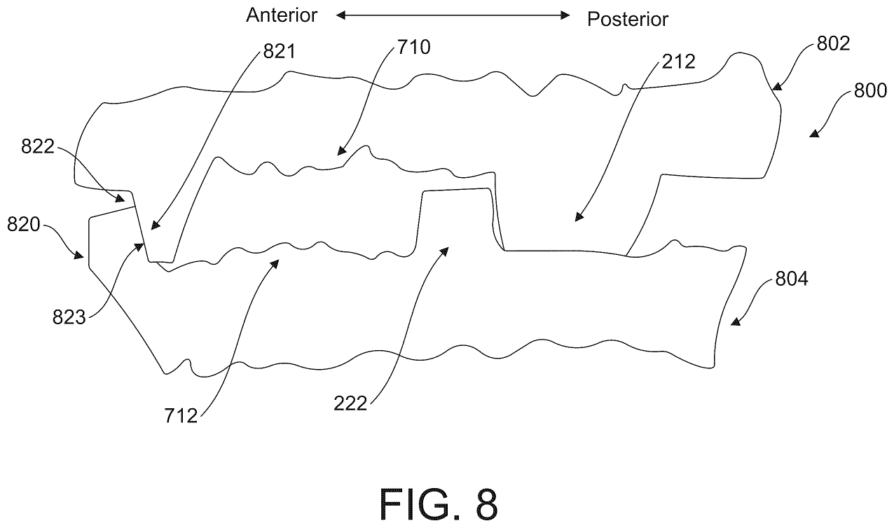

FIG. 8 depicts an embodiment of a system of aligners 802, 804 which may have the features of the aligners discussed herein. Occlusal blocks on the posterior teeth may be used for mandibular advancement treatment. In some embodiments, anterior blocks 822, 820 may be used on their own or in combination with the posterior occlusal blocks 212, 222. Aligners 802, 804 include occlusal blocks 212, 222 which may have some or all of the features of the occlusal blocks discussed herein. In addition, the aligners 802, 804 may include one or more anterior blocks 822, 820 over anterior teeth. The anterior blocks 822, 820, extend from the occlusal portion 710, 712 of the aligners 802, 804, such as beyond an occlusal plane of the aligners from which they extend.

The anterior blocks 822, 820, may include respective engagement surfaces 812, 823. When the patient wearing aligners 802, 804 having posterior occlusal blocks 212, 222 and anterior occlusal blocks 822, 820 closes their mouth, the occlusal blocks 212, 222, 822, 820, on the upper and lower aligners interact in a way that encourages the lower jaw to move forward, such as through contact of respective engagement surfaces 214, 224 on the occlusal blocks 210, 220 and engagement surfaces 821, 823 on the anterior occlusal blocks 821, 823. The occlusal blocks are arranged relative to each other such a patient wearing the aligners 802, 804 may not close their jaw in their natural occlusion. Instead, when the patient closes their jaws, the occlusal surfaces of the occlusal blocks may contact each other. A patient would shift their lower jaw relative to the upper jaw to slide the occlusal surfaces past each other allowing the patient to move their upper and lower arches into closer occlusion blocks and engaging the engagement surfaces against each other in order to hold the patient's lower jaw and upper jaw in an updated or corrected mesial distal arrangement. Over a series of stages of mandibular adjustment, the interaction of the occlusal blocks adjusts the relationship between the upper and lower jaw and over time causes changes in the patient's anatomy so that over time the aligners gradually reposition the natural location of the mandible into a more forward position to correct the patient's bite and improve alignment between the upper and lower jaws.

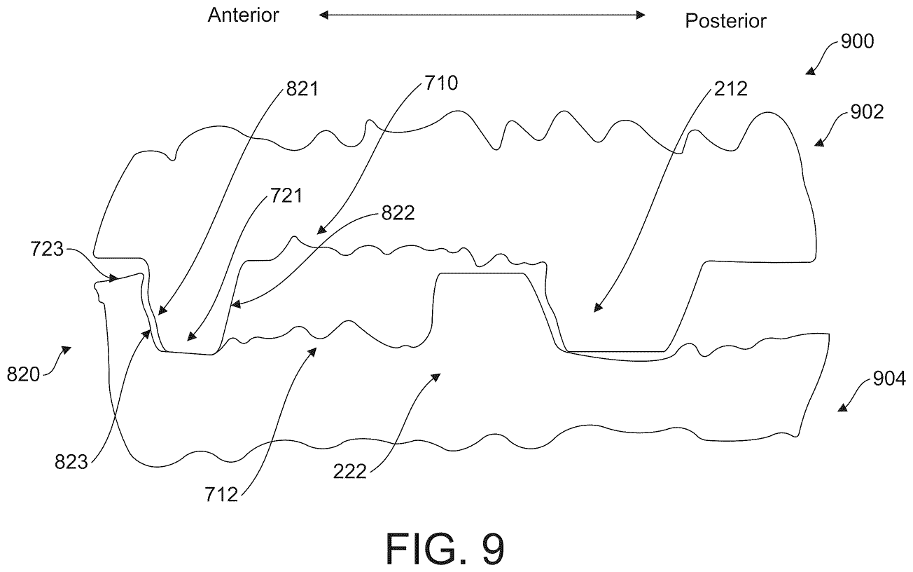

FIG. 9 depicts an embodiment of a system 900 of aligners 902, 904 which may have the features of the aligners discussed herein. The aligners 902, 904 incorporate the features and benefits of system 700 and 800. For example, the aligners 902, 904 include posterior blocks 212, 222 and anterior blocks 822, 820 that include respective engagement surfaces, such as 812, 823 that act to advance the mandible of the patient, such as described with respect to system 800. The aligners 902, 904 may also distribute the occlusal forces as described with respect to system 700. For example, the occlusal surfaces 721, 723 may engage with the aligners of the opposing arches to distribute the occlusal forces. However, they may contact the occlusal surfaces of the tooth receiving cavities of the opposing arch, rather than or as compared to contact on the opposing extensions 720, 722. In this way, the aligners 902, 904 may distribute the occlusal forces while also aiding in

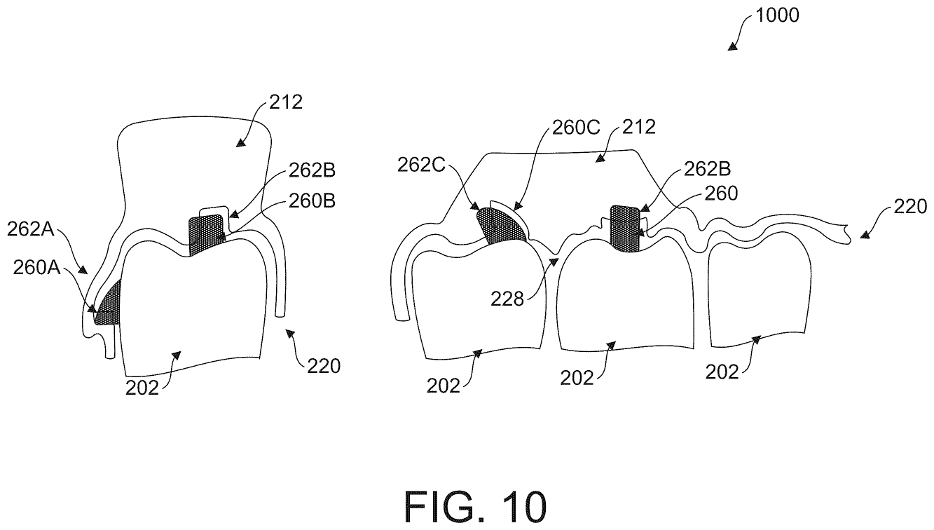

FIG. 10 depicts an orthodontic system 1000 including an aligner 220 and attachments 260 to move teeth 202. The aligner 220 may have some or all of the features of the aligners described herein. The aligner 220 may include attachment receiving cavities 262B, 262C, sometimes referred to as wells, on a lower or occlusal contacting surface 228 that are shaped to receive and apply a system of forces to corresponding occlusal attachments 260B, 260C in additional to buccal or lingual attachment 260A and attachment receiving cavity 262A.

One or more attachments which may be attached to preselected attachment locations on the teeth or dental features to provide forces and moments that an aligner acting directly on the tooth surface without an attachment may provide. Attachment devices may be bonded to the surface of the teeth in order to provide physical features which facilitate the application of controlled force. The attachment devices may be fixedly attached to the surface of a tooth or other dental feature in order to transmit force generated by the dental positioning appliance to the dental feature and/or to anchor the positioning appliance to teeth in order to permit the appliance to apply forces elsewhere in the patient's teeth. In such embodiments, the attachment device may act to assist in the transmission of force between the teeth and the dental positioning appliance.

Buccal attachments may be visible by people from outside the mouth. The occlusal attachments may be concealed under the occlusal blocks. The occlusal attachments also allow for greater moments to be applied to a tooth due to their distance from the center or rotation of the tooth.

With directly fabricated aligners, such as 3D printed aligners having occlusal features, such as mandibular advancement blocks, attachments may be placed on the occlusal surfaces underneath the features and hidden or occluded by the material of the aligner and the occlusal block. The left, front view of FIG. 10 depicts both a buccal surface attachment and the proposed occlusal surface attachment. The right, side view image shows two different occlusal attachments under an occlusal block imparting different types of forces on the teeth. Occlusal attachments may work with buccal or lingual attachments to create more complex force systems, movements, and/or couples to effect movement of the patient's teeth.

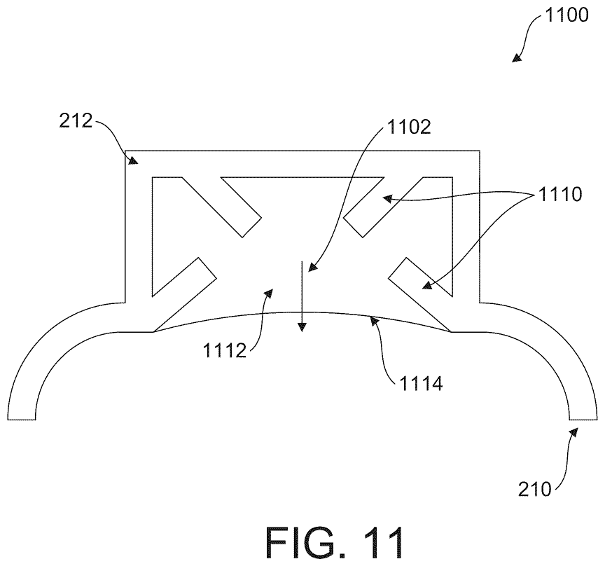

FIG. 11 depicts an apparatus 1100 including an orthodontic aligner 210 having an occlusal block 212 extending from an occlusal surface of the aligner 210. The aligner 210 and 212 may have some or all of the features described herein with respect to aligners and occlusal blocks. In some embodiments, a directly fabricated aligner 210 with an occlusal block 212 may include an occlusal block cavity 1112. Direct fabrication of such an aligner and occlusal may aid in curing the directly fabricated components and reduce deformation of the aligner during fabrication and curing. The aligner may include retention features 1110 that extend from walls, such as internal sidewalls and occlusal surfaces of the aligner and occlusal block into the cavity of the occlusal block. The retention features may aid in retaining support material such as cured epoxy 1114 within the cavity of the occlusal block. In some embodiments, when epoxy does not adhere to the surfaces of the aligner, the retention features may mechanically retain the epoxy or resin after curing. For example, the during fabrication, the aligner and occlusal block, along with the retention feature may be directly fabricated. Then, the cavity may be filled with a liquid epoxy which may be heat cured, a two-part epoxy that begins curing upon mixing, etc. When the epoxy is cured, it provides support to the occlusal block to aid in preventing collapse of the occlusal block under occlusal loads. However, epoxy may not strongly adhere to the aligner material or may separate from the aligner material under occlusal loads. In such cases, the epoxy or other support material may fall out of the cavity in a direction depicted by arrow 1102, which may be referred to as the Z-axis or in a gingival direction (when worn by the patient). The extensions 1110 extend into the support 1112 and resist removal of the support material from the cavity.

The extensions 1110 may extend from corners, such as, at the intersection of the occlusal surfaces of the sidewall or from the intersection of the tooth receiving cavity sidewalls and the occlusal block sidewalls. In some embodiments, an extension may extend at least 10% of the width and/or height of the occlusal block.

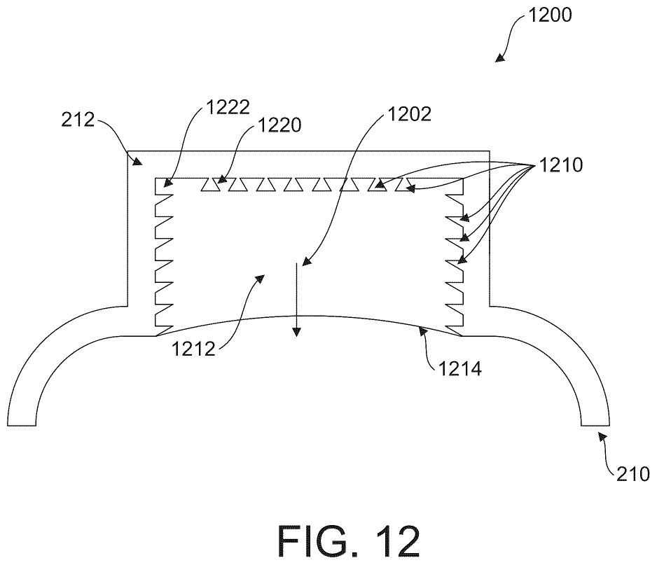

FIG. 12 depicts an apparatus 1200 including an orthodontic aligner 210 having an occlusal block 212 extending from an occlusal surface of the aligner 210. The aligner 210 and 212 may have some or all of the features described herein with respect to aligners and occlusal blocks. In some embodiments, a directly fabricated aligner 210 with an occlusal block 212 may include an occlusal block cavity 1212. Similar to the apparatus 1100, direct fabrication of such an aligner and occlusal may aid in curing the directly fabricated components and reduce deformation of the aligner during fabrication and curing. The aligner may include retention features 1210 that extend from walls, such as internal sidewalls and occlusal surfaces of the aligner and occlusal block into the cavity of the occlusal block. The retention features may aid in retaining support material such as cured epoxy 1214 within the cavity of the occlusal block. In some embodiments, when epoxy does not adhere to the surfaces of the aligner, the retention features may mechanically retain the epoxy or resin after curing and aid in preventing the epoxy or other support material may fall out of the cavity in a direction depicted by arrow 1102, which may be referred to as the Z-axis or in a gingival direction (when worn by the patient). The extensions 1110 extend into the support 1112 and resist removal of the support material from the cavity.

In some embodiments, an extension may extend between than 5% and 10% of the width and/or height of the occlusal block. In some embodiments, the retention features may have triangular cross sectional shapes. In some embodiments, the retention features 1210 may have undercuts 1220 that create overhangs in the epoxy material. For example, the retention features 1210 extending from the occlusal surface increase in width as a function of distance from the inner occlusal surface. The cure epoxy may form overhangs on each side of the retention feature that are captured by the retention feature, which aids in preventing the epoxy or other support material from being released from the cavity.

In some embodiments, the retention features 1210 may have flat upper surfaces 1222, upper being, e. g, a surface more occlusal than the other surfaces of the retention feature. The upper surface may be parallel to the occlusal plane to form a shelf that is angled and oriented to provide retention and prevent movement of the support in the Z-direction.

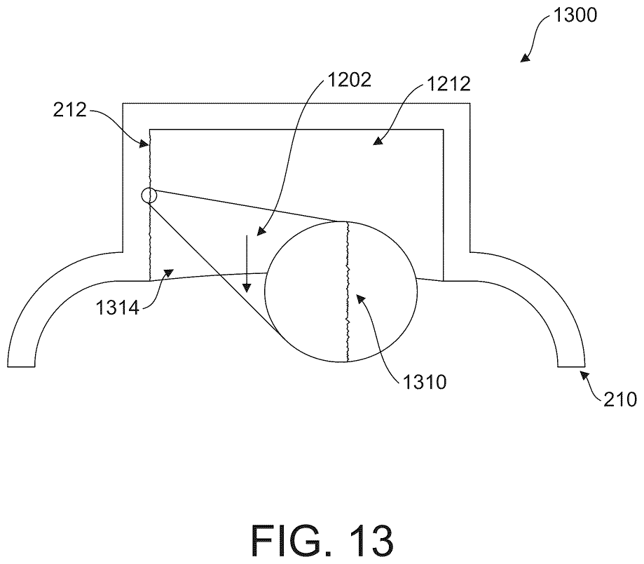

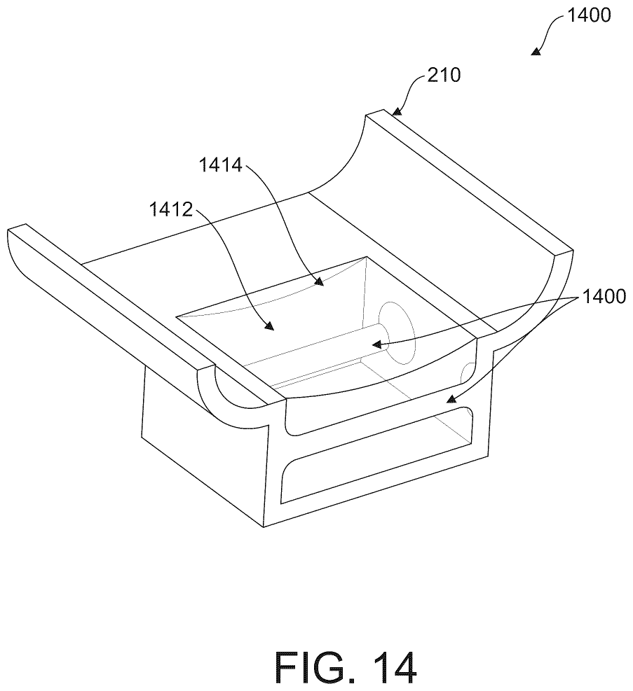

FIG. 13 depicts an apparatus 1300 including an orthodontic aligner 210 having an occlusal block 212 extending from an occlusal surface of the aligner 210. The aligner 210 and 212 may have some or all of the features described herein with respect to aligners and occlusal blocks. In some embodiments, a directly fabricated aligner 210 with an occlusal block 212 may include an occlusal block cavity 1212. Similar to the apparatus 1100, direct fabrication of such an aligner and occlusal may aid in curing the directly fabricated components and reduce deformation of the aligner during fabrication and curing. The aligner may include retention features 1310 that extend from walls, such as internal sidewalls and occlusal surfaces of the aligner and occlusal block into the cavity of the occlusal block. The retention features may aid in retaining support material such as cured epoxy 1314 within the cavity of the occlusal block.

The retention features 1310 may include surfaces formed using direct fabrication techniques, such as SLA printing, wherein the aligner 210 is formed layer by layer, each layer being formed and cured on top of a previous layer. The surface finish of the perimeters of each layer and/or the outer surfaces of the occlusal block sidewalls (the surface that faces the cavity 1212, may be fabricated with a surface finish, roughness, or texture that increase adhesion between the epoxy and the aligner material to mechanically retain the epoxy or resin after curing and aid in preventing the epoxy or other support material may fall out of the cavity in a direction depicted by arrow 1102, which may be referred to as the Z-axis or in a gingival direction (when worn by the patient).

FIG. 14 depicts an apparatus 1400 including an orthodontic aligner 210 having an occlusal block 212 extending from an occlusal surface of the aligner 210. The aligner 210 and occlusal block 212 may have some or all of the features described herein with respect to aligners and occlusal blocks. In some embodiments, a directly fabricated aligner 210 with an occlusal block 212 may include an occlusal block cavity 1412. Direct fabrication of such an aligner and occlusal may aid in curing the directly fabricated components and reduce deformation of the aligner during fabrication and curing. The aligner may include retention features 1410 that may be rods that extend across the cavity 1412 from one wall of the cavity to another. The retention features may aid in retaining support material such as cured epoxy 1414 within the cavity of the occlusal block.

The retention features may have a diameter or width that is at least 10% of the height of the occlusal block cavity to provide retention strength. The rods may extend in a mesial-distal direction or a buccal-lingual direction, as depicted in FIG. 14. In some embodiments, the rods may include bevels between the retention feature and the occlusal block cavity sidewalls. The bevel may have a radius that is less than a radius or width of the retention feature.

In some embodiments, the filler or support or epoxy material of FIGS. 10-14 may be a second direct-printed material with distinct properties from the primary direct-printed aligner, with each material being optimized for its specific target function. The aligner material may be selected to provide biomechanical tooth movement forces across the full dental arch and attachment activation for efficacy, whereas filler material may be optimized for strong adhesion to the aligner and for fracture toughness for crack and chip resistance while in use. Both materials may be directly fabricated into a single composite aligner to take advantage of the combined material properties.

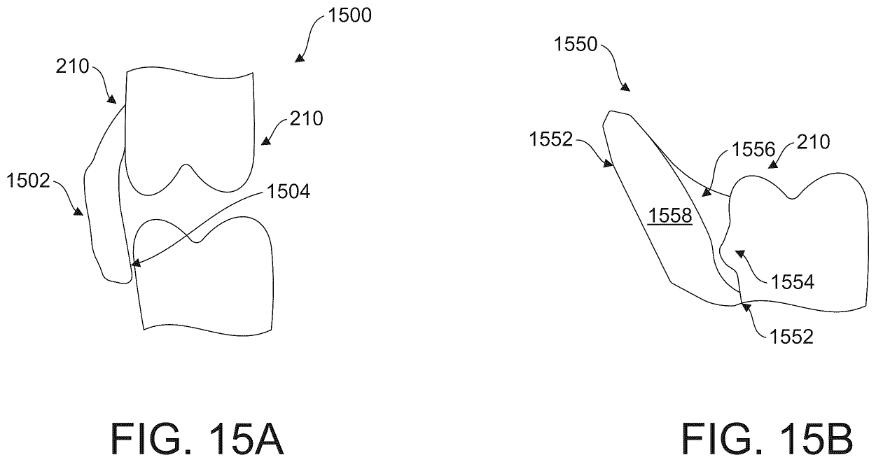

FIG. 15A depicts a wing 1502 which may be similar to and have one or more feature of the wings described herein. Direct fabrication allows for shapes that are not feasible using thermoforming methods. For example, the wing 1502 may have a surface 1504 that extends past the occlusal surface of both the tooth to which is extends form and an opposing tooth on an opposing arch of the patient. The surface 1504 may be formed to match the contours of the sidewall, such as a external buccal or lingual sidewall, of the opposing tooth. The surface shape 1504 may be generated based on a 3D model of the opposing aligner with an offset to provide clearance. The offset may be between 0.25 and 2 mm while following the contour of the opposing aligner.

FIG. 15B depicts and aligner 210 with a mandibular advancement wing. The mandibular advancement wing is has similar function as an occlusal block in that a wing of the lower arch interacts with a wing of the upper arch, such as through contact at respective engagement surfaces, to reposition the lower jaw relative to the upper jaw over one or more incremental repositioning stages though one or more respective locations towards a final arrangement. The wing 1550 extends from a side of a tooth receiving cavity of an aligner 210. The wing 1550 may extend from a buccal wall or lingual wall of a posterior tooth receiving cavity. In some embodiments, the aligner wall or tooth receiving cavity wall from which the wing extends, may extend to a gingival margin of the aligner. The wing 1552 may include a hollow cavity 1558 between an outer wall of the wing and an inner, tooth facing wall. The inner tooth facing wall may include a reinforcement portion 1556 that adds structural support to the wall. The reinforcement portion 1556 may have a thickens in a buccal-lingual direction from the sidewall of the tooth receiving cavity such that an attachment receiving cavity 1556 may be formed between the tooth receiving cavity and the wing 1550. The gingival end of the wing 1552 may include an aperture at the location where the outer wall of the wing joins the aligner sidewall. The aperture may allow resin to drain during direction fabrication or after direct fabrication, such as when using SLA fabrication processes. The reinforcement portion also aids in resisting deformation and crushing of the wing if a patient bites down on the wing. A distal end of the wing may extend beyond the occlusal surface of the patient's tooth or tooth receiving cavity of the aligner. Other features may be incorporated within the reinforcement portion between the tooth receiving cavity and the cavity of the wing, including buttons, compliance indicators, etc.

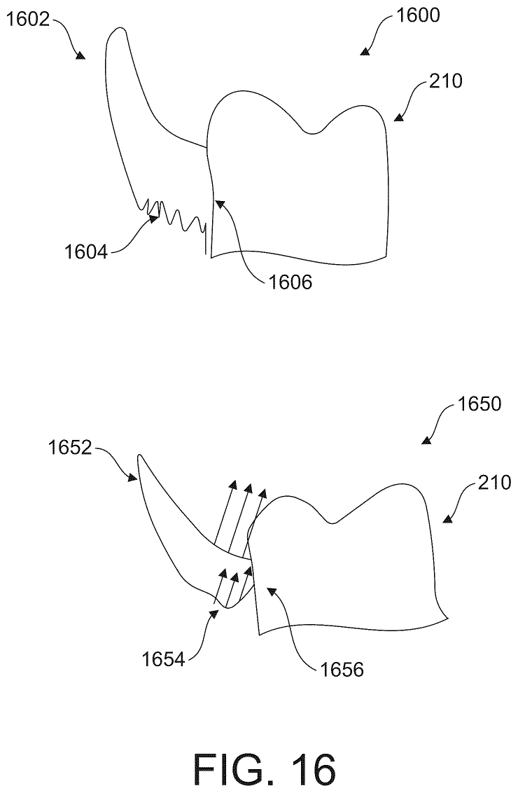

FIG. 16 depicts a system 1600 including an aligner 210 with an occlusal-distal compliant wing 1602. The wing 1602 may extend from a sidewall 1606 of the aligner 210.

The gingival end of the outer wall of the wing 1602 may include a compliant structure, such as a corrugations that extend mesial-distally such to form a hinge, such as a living hinge that allows from bending or rotation of the wing 1602 about the hinge while maintaining stiffness in the mesial-distal direction. Wings are designed to provide force in the mesial-distal direction in order to advance the jaw. Wings without hinges may be crushed by occlusal forces if a patient inadvertently bites on them. A living hinge may absorb some of the occlusal forces from inadvertent bites and allow the wing to bend without crushing or plastically deforming in a manner that compromises the mesial-distal stiffens of the wing.

FIG. 16 also depicts a system 1650 including an aligner 210 with an occlusal-distal compliant wing 1652. The wing 1652 may extend from a sidewall 1606 of the aligner 210. The gingival end of the outer wall of the wing 1652 may include a compliant structure, such as a thin portion 1654 at a location where the base of the wing where it extends from the sidewall 1656. The thing portion 1654 may have a thickness in a occlusal-gingival direction that increases along the length of the wing for a distance, such as less than 2 mm. The thinned portion 1654 may form a hinge, such as a living hinge that allows from bending or rotation of the wing 1602 about the hinge while maintaining stiffness in the mesial-distal direction. Wings are designed to provide force in the mesial-distal direction in order to advance the jaw. Wings without hinges may be crushed by occlusal forces if a patient inadvertently bites on them. A living hinge may absorb some of the occlusal forces from inadvertent bites and allow the wing to bend without crushing or plastically deforming in a manner that compromises the mesial-distal stiffens of the wing.

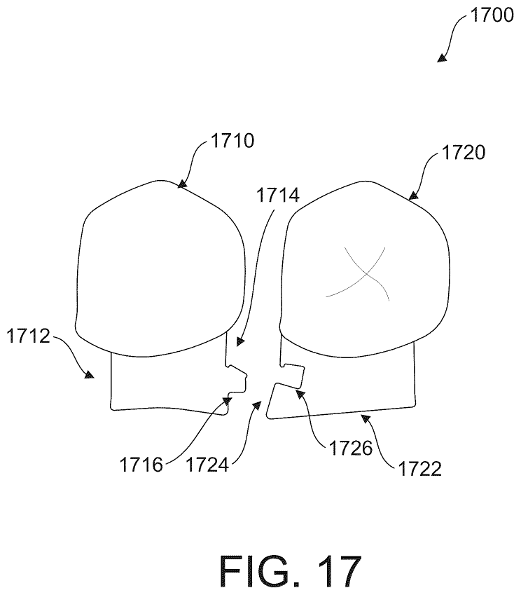

FIG. 17 depicts an occlusal-gingival view a portion of a system of appliance system 1700. The system 1700 includes a first appliance 1720 on a first arch of the patient and a second appliance 1720 on a second arch of the patient that opposes the first arch. The aligners may have some or all of the features of the aligners discussed herein. The first and second arch may be one of the upper the of a patient or a lower arch of a patient. Each appliance has a respective wing 1712, 1722 located on a buccal or lingual side of the appliance. The wings 1712, 1722 may have one, some, or all of the features described herein with respect to wings. Each wing has an engagement surface 1714, 1724 shaped to contact and transfer jaw moving forces to, for example, advance the mandible of the patient over one or more, such as a plurality, of stages. In some embodiments, the engagement surfaces may include a coupling such as coupling 1716 and coupling 1726. The coupling may be sliding or loos fit couplings that aid in maintaining buccal-lingual engagement of the wings when the patient's jaws are in occlusion. The couplings 1716, 1726 may including a coupling 1716 that is a protrusion that extends mesially-distally from a first of the wings that is shaped to be received in, e.g., mate with, a coupling 1726 that is a receptable. When the wings are in engagement and the coupled together, the couplings aid in resisting side to side movement of the jaws relative to each other. The cross-sectional profile of the couplings may be square, semicircular (e.g., one concave and one convex), triangular, or other shapes.

In some embodiments, the coupling may be a protrusion and a detent that provides tactile feedback to the user, such that the patient, when they close the arches in the proper occlusion, will feel the protrusion enter into the detent, which may slightly resist relative movement of the arches to indicate to the patient the preferred relationship between the jaws.

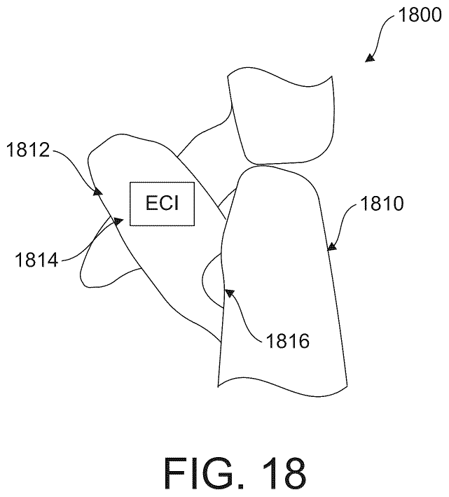

FIG. 18 depicts a system 1800 of aligners including wings. The aligner 1810 may have some or all of the features of aligners discussed herein. The aligner 1810 may include a wing 1812. The wing 1812 may include some or all of the features of the wings discussed herein. The wing 1812 may include one or more a stacked appliance features, such as compliance indicator 1814 which may be an electronic compliance indicator. The compliance indicator 1814 may be encapsulated within the wing 1812. The compliance indicator may be surrounded by appliance material such that it is retained withing the wing. In some embodiments, the compliance indicators may be fully and directly surrounded within the wing by appliance material. For example, the shape of the cavity in with the compliance indicator is located, maybe match the shape of the compliance indicator on all sides.

A compliance indicator measures or provides a way to observe a patent's compliance with wearing an aligner. The compliance indicator may provide human readable or observable compliance indication by changing physical or mechanical or visual properties that are readily observable by a human. In some embodiments, the compliance indication is machine readable. For instance, in one embodiment that alters the electrical characteristics of an appliance during wearing of the appliance, an electrical measurement can be made by a computer for detecting compliance. In another embodiment that uses biomarkers, a computer with biomarker sensor can be used with suitable computer program to detect compliance. In yet another embodiment, a color change can be detected by a computer vision program to detect compliance. The compliance indication may change based on an amount of use of the appliance by a patient.

For example, the compliance indicator 1814 may include a biodegradable polymer material. During use, the polymer material changes shape or size or color. For example, the volume of the biodegradable polymer material may be reduced during use. In some embodiments, the compliance indicator may be a button, such as a biodegradable polymer button. The button can be molded from a biodegradable polymer with the aligner. The button may have a predetermined degradation period such as a two week degradation period in the constant presence of oral fluids. Compliance may be measured based on the size or remaining volume of the compliance indicator after a period of time, which may be predetermined.

The compliance indicator may be an electronic compliance indicator that measures the time the appliance is applied to the tooth based on a sensor, such as a position sensor or switch that is activated when the appliance is worn by a patient. A humidity sensor may be used, and a timer activated when the humidity sensor measures a humidity consistent with the aligner being worn by a patient. Other compliance sensors may also be used.

The wing 1812 may include stacked features, wherein the wing includes more than one feature. For example, the wing 1812 is stacked with an attachment receiving cavity 1816 that may have some or all of the features of an attachment receiving cavity discussed herein.

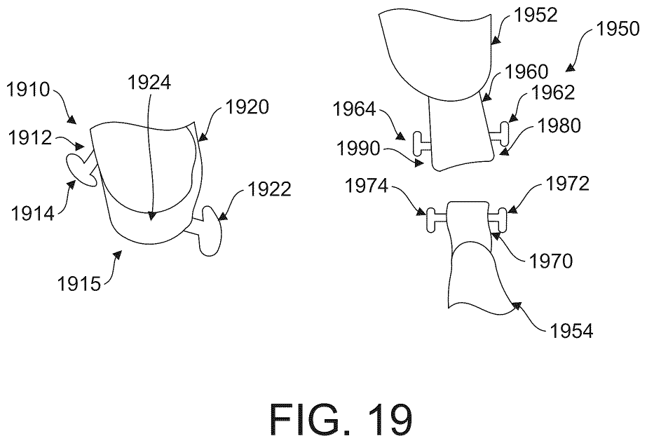

FIG. 19 depicts an orthodontic system 1910 includes a button 1914 affixed to a tooth 1912, an aligner 1920, and an elastic. The aligner includes a tooth receiving cavity that is shaped relative to the shape of the tooth to include an occlusal gap 1924 between the occlusal surface of the tooth and the inner occlusal surface of the tooth receiving cavity with the aligner 1920 is worn by the patient. The aligner may also include a button 1922. The button 1914 that is attached to the tooth may be located on a first side of the tooth, such as a buccal or lingual side of the tooth. In some embodiments, the button on the aligner may be located on the aligner on an opposite side of the tooth, such as the other of the buccal or lingual side.

An elastic, such as an elastic band may be configured to engage with the button 1914 on the tooth and the button 1922 on the aligner to exert a force on the tooth to extract the tooth in an occlusal direction to bull the tooth into the gap in the tooth receiving cavity.

FIG. 19 also depicts system 1950 which may be a system of aligners 1952, 1954. The aligners may have some or all of the features of the aligners discussed herein. Each of the aligners 1952, 1954 may have a respective occlusal block 1960, 1970. The occlusal blocks 1960, 1970 may have some or all of the features of occlusal blocks discussed herein. Each of the occlusal blocks 1960, 1970 may have buttons 1962, 1964, 1972, 1974 attached to buccal and lingual sides of the blocks 1960, 1970.

One or more, including a plurality, of elastics may extend between the buttons to exert an extraction force on aligners which may be transferred to the tooth or teeth retained within the aligner. For example, a first elastic 1980 may engage at a first end with the button 1962 on a first side of the occlusal block 1960 on an aligner 1952 on a first arch and a second end of the elastic 1980 may engage with button 1974 on a second side of the occlusal block 1970 on an aligner 1954 on a second arch, opposing the first arch. Similar a second elastic 1990 may be coupled at a first end with the button 1964 on a second side of the occlusal block 1960 on the aligner 1962 on the first arch and the elastic 1990 may be coupled at a second end with the button 1972 on a first side of the occlusal block 1970 on the aligner 1954 on the second arch.

The elastics may generate tooth extraction forces that are transferred though the buttons, occlusal blocks, and aligners, to a tooth or teeth received within the respective aligners to extract the tooth or teeth.

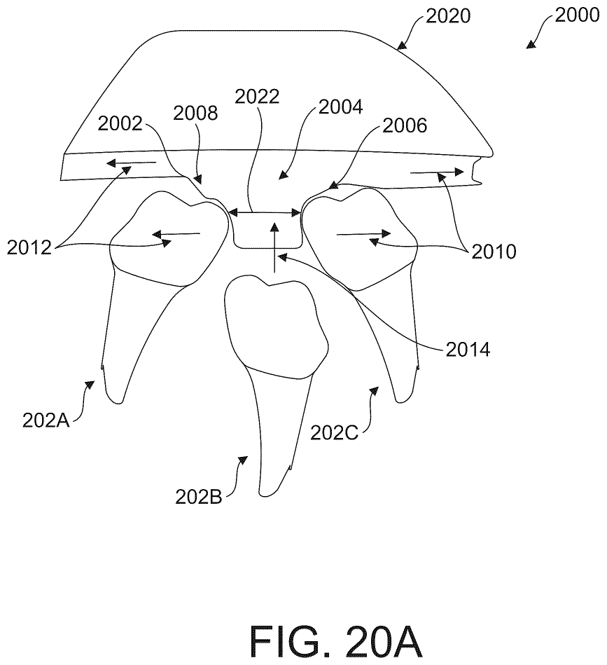

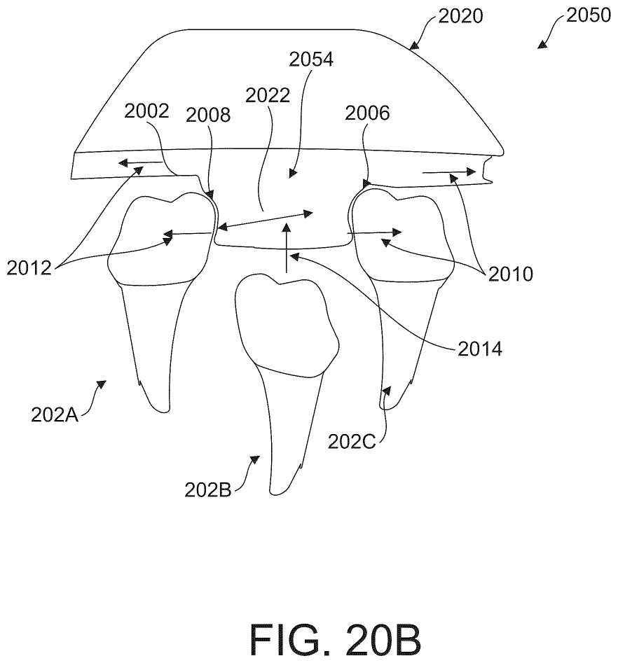

FIG. 20A depicts a cross section of an aligner 2000 that is configured to reposition teeth 202A, 202C to make room for an erupting tooth 202B. The aligners may have some or all of the features of aligners herein, including some or all of the features of occlusal blocks described herein. The aligner includes an expansion member 2004 that extends between two tooth receiving cavities that receive tooth 202A and tooth 202C. The expansion member 2004 may extend from an inner surface 2002 of an occlusal portion of the aligner between the teeth 202A, 202C or corresponding tooth receiving cavities shaped to receive the teeth 202A, 202B. The expansion member may have surface shapes 2008, 2006 that correspond to the shape of the teeth 202A, 202C, respectively. The surface shapes 2008, 2006 may be repositioned relative to the location of the teeth 202A, 202C such that when the aligner 2000 is placed on the teeth of the patient, the expansion member applies forces 2012, 2024 against the crows of the teeth 202A, 202C to rotate and/or translate the teeth away from each other to provide space for the tooth 202B to erupt between the teeth 202A, 202C in an occlusal direction 2014.

In some embodiments, an expansion member 2004 may be useful in some orthodontic treatment, such as in a treatment for a patient who has a large gap, such as an interproximal gap, between two tipped adjacent teeth. 202A, 202C. The expansion member may be protrusion, such as protrusion 230, discussed above, that includes an infilled region that infills the gap. The gap may be spanned with a long occlusal block 2020 and a spacer, such as an expansion component or member 2004 that may grows in size, such as width 2022 between the crowns of the teeth 202A, 202C with each or a plurality of stages of a treatment plant to upright adjacent crowns and create space. In some embodiments, a treatment plan may use such an aligner when a baby tooth falls out and there is not enough room for adult tooth to come into the jaw line between the existing, adjacent teeth. In some embodiments, this may also be used to open up mesial distal space or upright tipped crowns to allow for a restorative surgical implant to be placed after the space is opened and the crowns moved upright.

FIG. 20B depicts a cross section of an aligner 2050 that is configured to maintain the position of teeth 202A, 202C to maintain the gap between teeth 202A, 202C for an erupting tooth 202B. The aligners may have some or all of the features of aligners herein, including some or all of the features of occlusal blocks described herein. The aligner includes a space maintenance member 2054 that extends between two tooth receiving cavities that receive tooth 202A and tooth 202C. The maintenance member may be protrusion, such as protrusion 230, discussed above, that includes an infilled region that infills the space between the teeth. The space maintenance member 2054 may extend from an inner surface 2002 of an occlusal portion of the aligner between the teeth 202A, 202C or corresponding tooth receiving cavities shaped to receive the teeth 202A, 202B. The expansion member may have surface shapes 2008, 2006 that correspond to the shape of the teeth 202A, 202C, respectively. The surface shapes 2008, 2006 may be positioned relative to the location of the teeth 202A, 202C such that when the aligner 2000 is placed on the teeth of the patient, the space maintenance member 2054 applies forces 2012, 2024 against the crowns of the teeth 202A, 202C to maintain their position and orientation to provide space for the tooth 202B to erupt between the teeth 202A, 202C in an occlusal direction 2014. In some embodiments, space maintenance member 2054 may provide less force than would cause tooth movement. In some embodiments, space maintenance member 2054 may provide no force to the teeth.

In some embodiments, aa space maintenance member 2054 may be useful in some orthodontic treatment, such as in a treatment for a patient who has a large interproximal gap between two tipped adjacent teeth. 202A, 202C. The gap may be spanned with a long occlusal block 2020 and a spacer, such as space maintenance component or member 2054 maintains its size, such as width 2022 between the crowns of the teeth 202A, 202C with each or a plurality of stages of a treatment plant to the position of the crowns and the interproximal space. In some embodiments, a treatment plan may use such an aligner when a baby tooth falls out to prevent adjacent tooth from tipping or moving to close the interproximal space.

In some embodiments, the extensions 2054, 2004 may be formed using shape optimization techniques to reduce stress concentrations. For example, the occlusal/tooth facing or distal surface of the extensions may be shaped to follow the contours of the teeth and may have the radius of otherwise sharp inside corners increased.

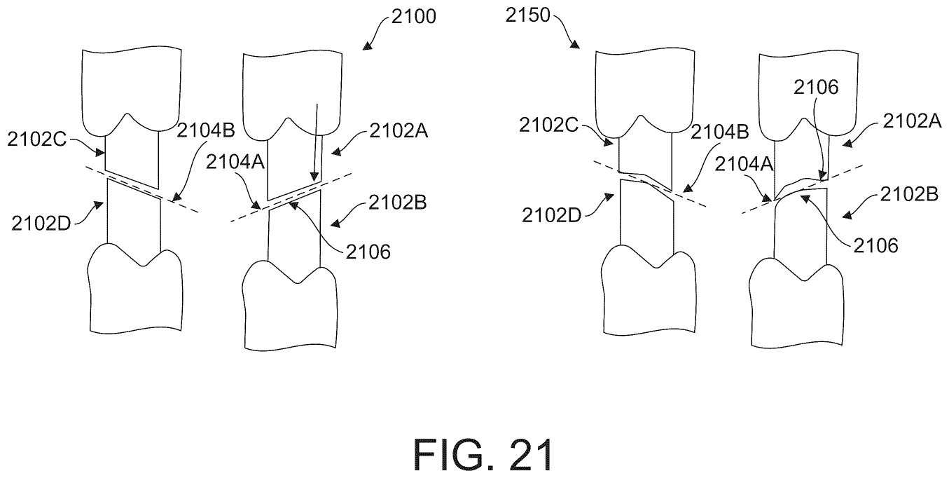

FIG. 21 depicts a posterior cross section of an aligner system 2100 configured to align the upper and lower arches of the patient as they move their arches into occlusion. The cross section shown may be through posterior tooth receiving cavities with occlusal blocks therein. The aligners may have some or all of the features of aligners discussed herein, including some or all of the features of the occlusal blocks discussed herein. The occlusal surfaces 2106 of the occlusal blocks 2102 may be inclined or rotated at angle or angles 2104 with respect to the occlusal plane of the patient's dentition, for example, such that they are not parallel to the occlusal plane. Each pair of occlusal blocks, such as the first pair 2102A, 2102B and the second pair 2102C, 2102D may have their occlusal surfaces inclined at the same respective angle 2104A, 2104B. The angles 2014 maybe angled such that the buccal side of an occlusal block is either lower or higher than a lingual side of the occlusal block. Such an arrangement may allow a patient to align their upper and lower arches buccal-lingually when the block come into occlusion and before the patient adjusts the mesial-distal position of their lower jaw to engage the engagement surfaces of the occlusal blocks. Wings discussed herein may also include occlusal facing surfaces that have similar angular relationships.

In some embodiments, the angled occlusal surfaces of the occlusal blocks may allow the aligners to centralize how the lower jaw engages the upper jaw as it closes (e.g., comes into occlusion). The two left and right ramps help the patient find the central midpoint or proper upper and lower arch or jaw relationship. Some patients have difficulty when occlusal block occlusal surfaces are flat and parallel to each other, because the lower jaw can slide out of alignment, and it takes increased effort to engage both the left and right blocks simultaneously. The angle occlusal surfaces may be used in treatment plans allow aid in providing muscular jaw-based midline correction or angular cant correction treatment is identified whereby the design of the blocks are either deliberately offset or activated to re-train the bite occlusion.

FIG. 21 also depicts a posterior cross section of an aligner system 2150 configured to align the upper and lower arches of the patient as they move their arches into occlusion similar to that of system 2100. The system 2150 has the same features as system 2100, expect the occlusal surfaces 2106 may have curved shapes, such as convex and concave mating surfaces shapes. The curved shapes may form a type of joint wherein the concave surface is a receptacle for the ball of the curved surfaces. The curved shapes may further aid in the patient finding and maintaining the appropriate or corrective buccal-lingual relationship between their upper and lower arches.

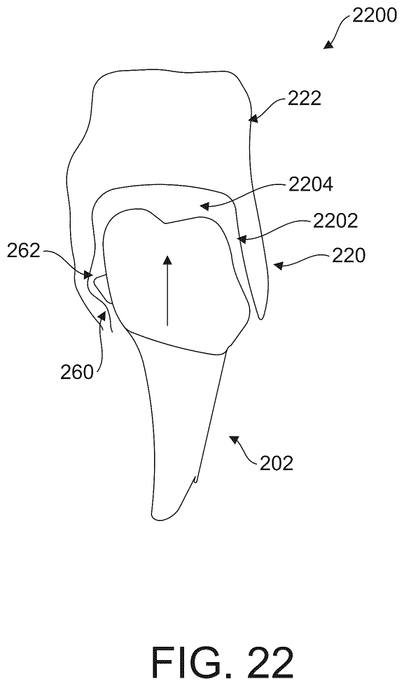

FIG. 22 depicts a cross section of an orthodontic system 2200 including an aligner 220 having an occlusal block 222 and an attachment receiving cavity 262 in a sidewall of a tooth receiving cavity 2203. The aligner 220 may have some or all of the features of aligners discussed herein. The occlusal block 222 may have some or all of the features of the occlusal blocks discussed herein. As discussed herein, the occlusal forces applied to occlusal blocks may cause the teeth under the occlusal blocks to intrude, which may case posterior open bite. In some embodiments, the tooth receiving cavity 2202 may be offset from the occlusal surfaces of the patient's tooth. For example, the tooth receiving cavity 2202 is offset to create a gap 2204 between the occlusal surface of the tooth 202 and the bottom surface of the occlusal block (or the upper/inner occlusal surface of the tooth receiving cavity that aids in preventing the occlusal forces from intruding the tooth 202. In some embodiments, an attachment receiving cavity may be formed in a sidewall of the tooth receiving cavity 2202. An attachment 260 may be attached to the tooth 260. The attachment and attachment receiving well may aid in providing extrusion forces on the tooth to counteract intrusion forces from the occlusal block. In some embodiments, the tooth may have attachments on both the buccal and lingual sides with the aligner having corresponding attachment receiving wells on both the buccal and lingual sides.

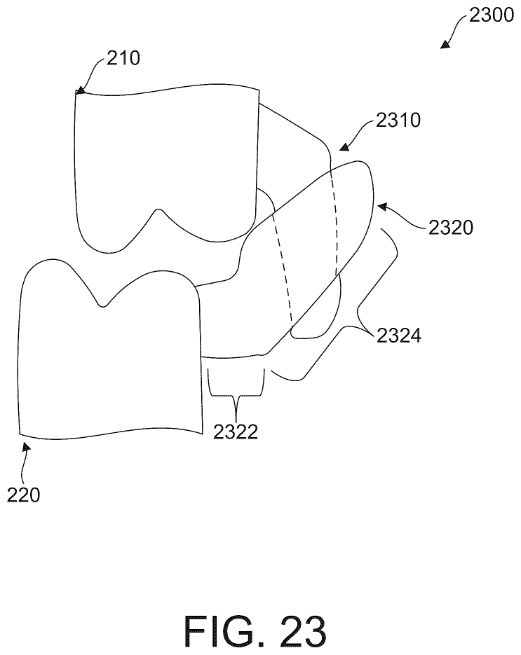

FIG. 23 depicts a system 230 of aligners 210, 220 with wings 2310, 2320 for use in treatment plans where for posterior cross bites and/or poor alignment of upper and lower jaws is identified during the treatment planning process or malocclusion analysis process. With thermoformed aligners, many shapes of wings are not able to be produced because the thermoformed aligner is removed from the mold after fabrication. A direct fabrication process does not use a mold allowing move advanced and different shapes. The 2320 includes a laterally extending portion 2322 from which the occlusally extending portion 2324 of the wing extends. The laterally extending portion may have a length of withing 70% 130% of the offset distance between the mesial-distally extending centerline of the upper and lower teeth. The distance may also be based on the crossbite offset or degree of crossbite between the upper and lower teeth. The laterally extending portion may extend buccally from the buccal sidewall of the tooth receiving cavity of the aligner 220 between the sidewall and the occlusally extending portion of the wing.

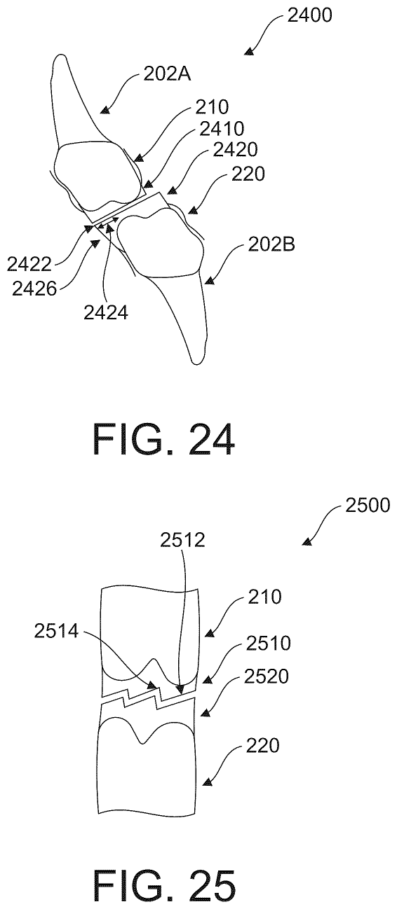

FIG. 24 depicts a system 2400 of aligners 210, 220 having occlusal blocks 2410, 2420 extending from the occlusal surfaces of the aligners 210, 220. The aligners 210, 220 may have some or all of the features of the aligners discussed herein. The occlusal blocks 2410, 2420 may have some or all of the features of the occlusal blocks discussed herein. The teeth 202A, 202B are offset relative to each other, such as in a case with crossbite. With such cases, the occlusal blocks 2410, 2420 may not overlap as much as desired, which can lead to engagement, lack of stability, lack of comfort, and patient compliance issues due the difficulty in achieving proper engagement between offset occlusal blocks. Extending one of the occlusal blocks beyond the natural termination boundary of the occlusal surface of the tooth may increase the engagement, stability, comfort, and compliance in such situations. The occlusal block may include an extension 2422 that may extend a distance 2424 beyond the natural termination boundary of the occlusal surface of the tooth. The extension may be beveled towards the tooth in order to support the extension. In some embodiments, the support portion 2426 of the extension 2424 may include a structural gusset or flying buttress that extends from the sidewall of the aligner to the extension 2422.

FIG. 25 depicts a system 2500 of aligners 210, 220 with occlusal blocks 2510, 2520 extending from the occlusal surfaces of the aligners 210, 220. The aligners 210, 220 may have some or all of the features of the aligners discussed herein. The occlusal blocks 2510, 2520 may have some or all of the features of the occlusal blocks discussed herein. In some embodiments, for each stage of treatment in a treatment plan, two sets of aligners may be designed. In some embodiments, two sets of aligners may be provided to the patient. The aligners may be daytime aligners for use during the day and nighttime aligners for use while sleeping. The daytime aligners may include occlusal blocks with relatively flat surface shapes that allow for talking and regular jaw movements. The nighttime aligners, as depicted in FIG. 25 may include surface features that cooperate with each other to prevent movement of the lower jaw relative to the upper jaw when the jaws are in engagement. The engagement features may be a sawtooth pattern that includes a relatively low sloped portion 2512 that permits sliding engagement between the upper and lower blocks in one direction with a relatively steep or steeper, such as vertical slope 2510 between the low sloped portions that resists jaw movement, such as mesial-distal jaw movement in one direction when the jaws are in occlusion. For example, the features may permit forward movement of the lower jaw, but resist backward or mesial movement. The blocks 2510, 2520 may hold the patient's lower jaw in a forward position to reposing the jaw even when the patient relaxes their jaw muscles.

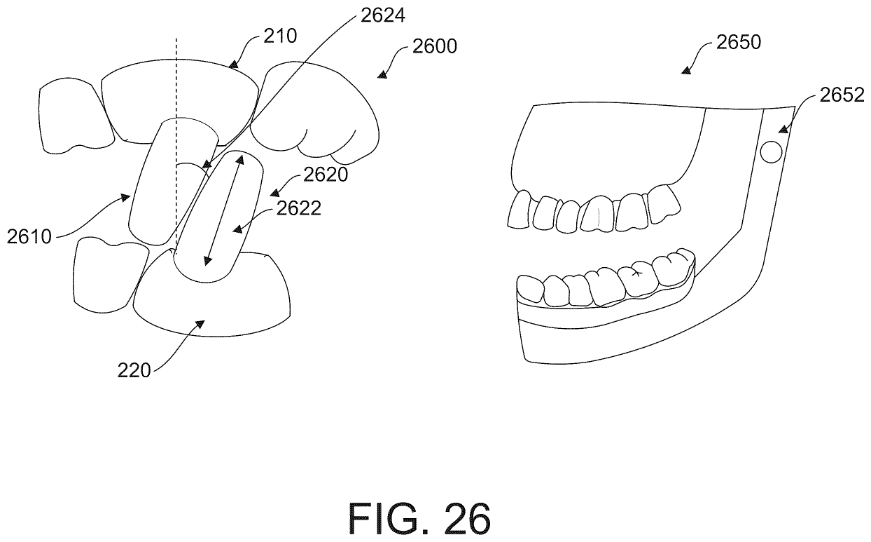

FIG. 26 depicts a scan 2650 of the patient's upper and lower jaws and a system 2600 of aligners 210, 220 having wings 2610, 2620. The scan 2650 may be one or more scans of the patient's jaws and other jaw structures, such as the TMJ 2652. The scans 2650 may be used in treatment planning to determine how the arches move into and out of occlusion. Based on these scans, an articulation model may be built, such as depicted in FIG. 26. The articular model may be used to determine heights and angles at which wings for aligners may be generated to allow for natural and/or comfortable articulation of the jaws, such as by allowing the wings to move past each other during initial occlusion. The aligners 210, 220 may be generated with wings 2610, 2620 having heights 2622 and angles 2624 based on the articulation model that allow the wings to move past each other during the initial portion of the jaws coming into occlusion with engagement of the wings as the jaws come into full occlusion. The height 2622 may be a height above the occlusal surface of the aligner from which the wing extends. In some embodiments, the height maybe a gingival-occlusal distance of the wing from a base of the wing to the occlusal/distal tip of the wing. The angle may be an angle from vertical, with vertical being perpendicular to the occlusal plane of the aligner.

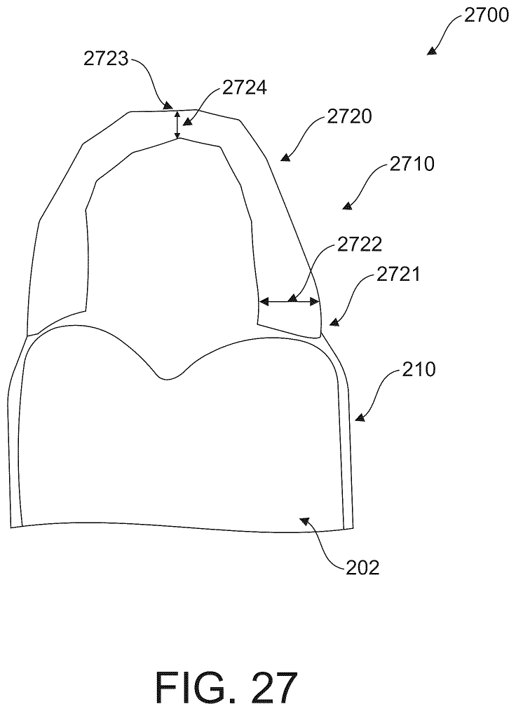

FIG. 27 depicts an orthodontic system 2700 include an aligner 210 having an occlusion block 2710. The aligner 210 may have some or all of the features of the aligners discussed herein. The occlusal block 2510 may have some or all of the features of the occlusal blocks discussed herein. The orthodontic system 2700 is shown in a buccal-lingual cross section. The occlusal block 2710 may include a variable thickness cross section. For example, the occlusal block may include an arch cross sectional shape in the buccal-lingual direction. The bases 2721 may have a first thickness 2722 measured between the interior surface to the exterior surface, for example, in a direction normal to one of both of the exterior surface and the interior surface at the base. The apex 2723 or occlusal portion of the arch may have a second thickness 2724 measured between the interior surface to the exterior surface, for example, in a direction normal to one of both of the exterior surface and the interior surface at the apex. The first thickness at the base may be greater than the second thickness. The thickness may gradually reduce along the arch from the first thickness at the base to the second thickness at the apex. The arch shape may allow for the transfer of occlusal forces on the apex to the base. The bases of the arch may contact to the occlusal surface of the tooth 202 when worn by the patient. The shape of the bases of the arches may match the shape of the occlusal surfaces of the tooth at the contact locations o the tooth. The bases may be shaped to engage with cusps of the tooth 202 to transfer the forces to the occlusal surfaces, include the cusps of the tooth. Such a shape mya allow the occlusal forces on the occlusal block to be transferred to the tooth without crashing the occlusal block.

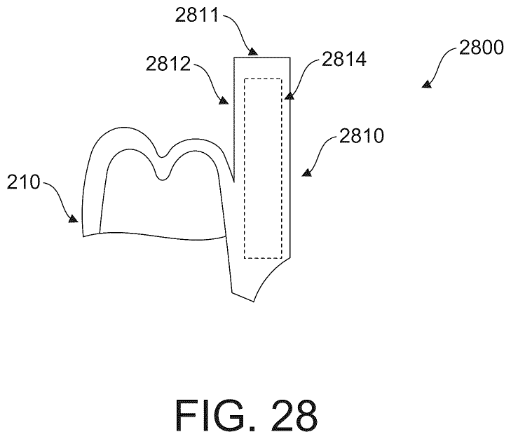

FIG. 28 depicts an aligner 210 with a buccal feature 2810. The buccal feature 2810 may extend from the buccal side of a tooth receiving cavity of the aligner 210. The feature 2810 may extend a first distance in a buccal direction and second distance in an occlusal direction. The first distance may be at least 20% of the width of a patient's tooth or of the tooth receiving cavity. The second distance may be at least 50% of the crown height or the height of the tooth receiving cavity from which the feature extends. The feature 2810 may be shaped to receive an elastic between a lingual side 2812 of the extension and the external surface of the tooth receiving cavity. In some embodiments, the lingual side of the feature may act against the buccal side of a tooth on an opposing arch to prevent lateral movement of the arch beyond the buccal feature.

In some embodiments, one or more of the surfaces 2810, 2811, 2812 may be flat to provide a consistent surface for later adhering or otherwise coupling aligner features or auxiliaries, such as buttons, hooks, etc. In some embodiments, the wing 2800 may include an interior cavity 2814. The cavity may be filled with hydrogels comprising drugs, for delivering drugs to the oral cavity of the patient. The aligner may be semipermeable to aid in drug delivery from the cavity to the oral cavity. In some embodiments, the cavity may comprise a sensor, such as an electronic compliance indicator, temperature sensor, force sensor, or other sensor.

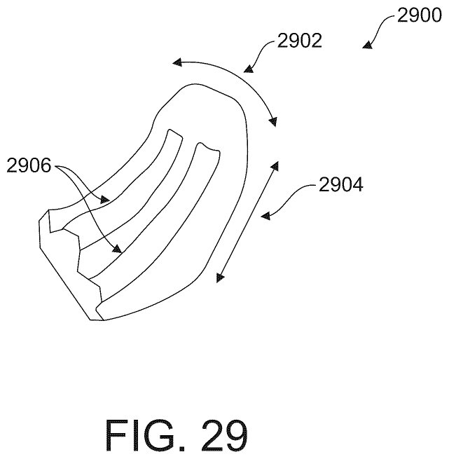

FIG. 29 depicts an embodiment of a customizable wing 2900 that allows for adjustment of the angle 2902 of the wing and the protrusion 2904 during treatment planning to provide improved articulation of the arches. For example, a doctor may provide input on a displayed version of the wing to adjust the mesial-distal angle 2902 about a buccal-lingual axis and the protrusion 2094 to provide for improved articulation tan avoid the wing or wings coming into contact in a manner that interference with the patient's articulation.

The angle 2902 and the length of the protrusion of the wing may be adjusted based on orthodontic tooth movements or jaw movements to aid in jaw articulation. The wing 2900 may also include one or more ribs 2906 that extend along the length of the wing to increase rigidity of the wing. In some embodiments, the wing may be hollow or partially hollow and open to aid in draining resin during direct fabrication processes and to reduce resin usage.

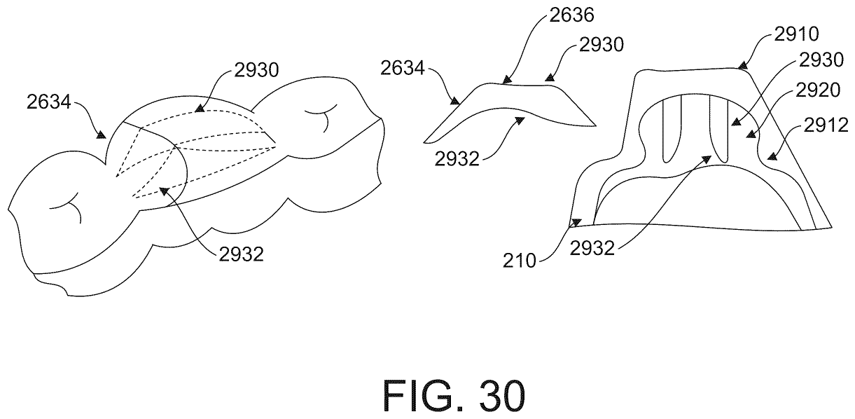

FIG. 30 depicts three views of an orthodontic aligner 210 with an occlusal block 2910 having supporting ribs 2930. From left to right are an isometric view, a cross sectional view cut mesially-distally along the mesial-distal length of a rib 2930, and a crosse sectional view cut buccal-lingually though the aligner and occlusal block. The occlusal block 2910 includes sidewalls and an occlusal wall. The sidewalls are support by buccal and lingual bases 2912 that are shaped to fit the occlusal surfaces of the tooth on which the block is placed when the aligner is worn by a patient. The sidewalls and occlusal walls form a cavity 2920 that may be open to the tooth receiving cavity of the aligner. The one or a plurality of ribs may extend from the occlusal surface of the inner occlusal surface of the cavity 2920 to a surface 2932 that may be configured to contact the occlusal surface of the tooth when the appliance is worn by the patient. The surface 2932 may have a shape that matches the shape of the tooth or teeth over which the ribs extend when worn by the patient. In some embodiments, the ribs also extend from the front to the back of the occlusal block, such as from an engagement surface 2634 to the opposite surface of the block 2910.

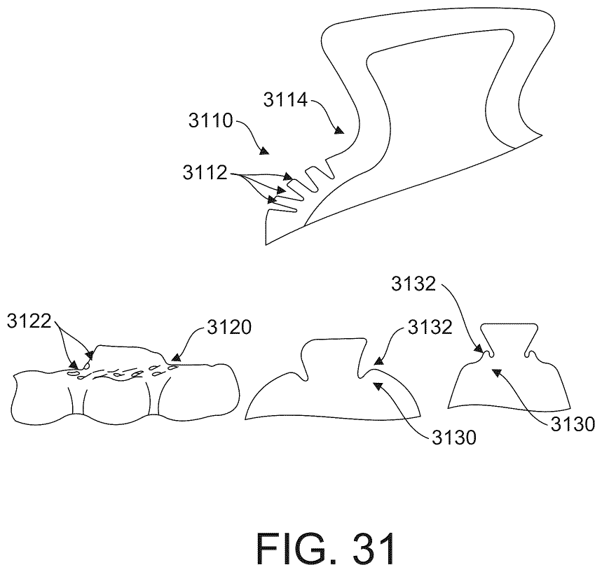

FIG. 31 depicts embodiments of aligners with living hinges and other features to reduce stress concentrations at the base of occlusal blocks, such as at locations where the sidewalls of the occlusal blocks transition to the aligner tooth receiving cavity walls. Occlusal blocks may experience plastic deformation, such as crushing and buckling at the base of their sidewalls. Living hinges and other stress relief features may aid in reducing plastic deformation at the base of the sidewalls. For example, living hinge 3110 may include one or a plurality of channels 3112 that extend parallel to each other and along the length of the base of the sidewall 3114 of the occlusal block. The living hinge 3110 allows for greater elastic deformation of the aligner before plastic deformation permanently deforms the aligner.

In some embodiments, a living hinge 3130 may include a single channel and a protrusion or wall 3132 that extends occlusally along the sidewall of the occlusal block. The channel acts as a living hinge to provide for greater elastic deformation while the wall 3132 acts to limit the deformation and potential buccal-lingual tipping of the occlusal block.

In some embodiments, a stress relief 3120 may be formed around the occlusal block. The stress relief, which may be a living hinge, may include a plurality of perforations 3122 or apertures through the aligner material at the base of the occlusal block sidewalls where the sidewalls join the tooth receiving cavity walls. The perforations 3122 elastically deform and allow the aligner to elastically deform and absorb the occlusal forces on the occlusal block.

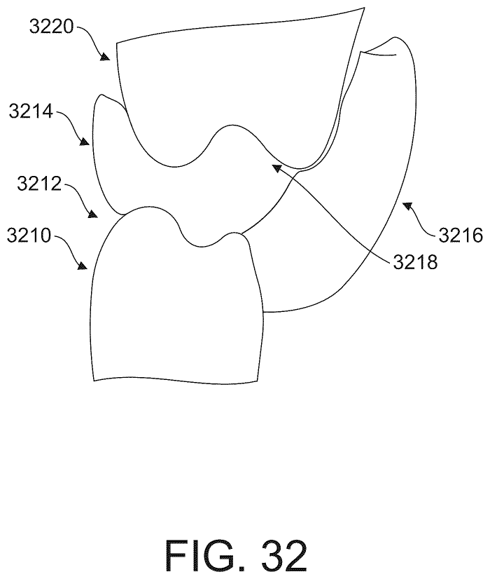

FIG. 32 depicts a system of aligners 3210, 3220. The aligner 3210 includes an occlusal block 3212 with buccal and lingual wings 3214, 3216. The aligners, occlusal blocks, and wings may have some of all of the features of the aligners, occlusal blocks, and wings discussed herein. The occlusal surface 3218 of the block may be shaped to match the external occlusal surface of the aligner 3220 of an opposing arch of the patient. The wing 3214 may extend in lingual and occlusal directions from the occlusal block 3212 or aligner 3210. The wing 3214 may have a buccal surface that faces a lingual surface of the opposing aligner 3220. The buccal surface may be shaped to match the lingual surface of the opposing aligner. The wing 3216 may extend in buccal and occlusal directions from the occlusal block 3212 or aligner 3210. The wing 3216 may have a lingual surface that faces a buccal surface of the opposing aligner 3220. The lingual surface may be shaped to match the buccal surface of the opposing aligner. The blocks and wings may form an occlusal trough that receives the opposing aligner therein.

The wings 3216, 3214 aid in lateral guidance of the upper arch with respect to the lower arch as the patient brings their arches into occlusion. The buccal and lingual wings may create a channel or trough for receiving the opposing arch and guiding it into occlusal. For example, when the upper and lower arches are laterally offset, one or both of the inner surfaces of the wings may contact the tooth or aligner on the opposing arch. The tooth or aligner on the opposing arch may slide along the surface until contacting the occlusal surface of the occlusal block, bringing the upper and lower arches into spaced occlusion.

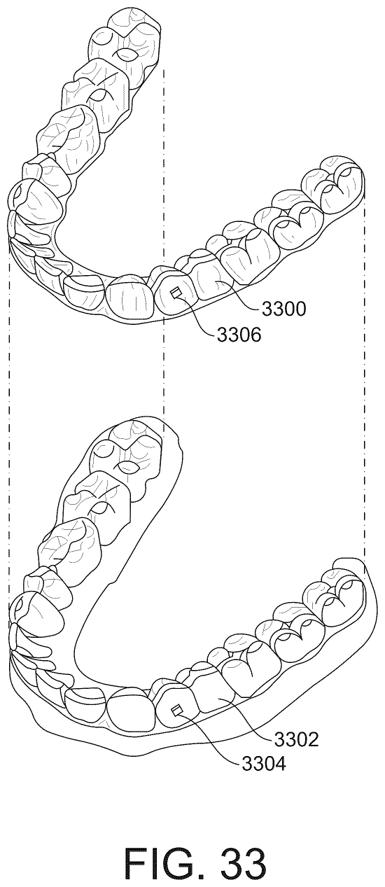

FIG. 33 illustrates an exemplary tooth repositioning appliance 3300, such as an aligner that can be worn by a patient in order to achieve an incremental repositioning of individual teeth 3302 in the jaw. The appliance 3300 may include all of the features of the aligners and appliances discussed herein. The appliance can include a shell (e.g., a continuous polymeric shell or a segmented shell) having teeth-receiving cavities that receive and resiliently reposition the teeth. An appliance or portion(s) thereof may be indirectly fabricated using a physical model of teeth. For example, an appliance (e.g., polymeric appliance) can be formed using a physical model of teeth and a sheet of suitable layers of polymeric material. The physical model (e.g., physical mold) of teeth can be formed through a variety of techniques, including 3D printing. The appliance can be formed by thermoforming the appliance over the physical model. In some embodiments, a physical appliance is directly fabricated, e.g., using additive manufacturing techniques, from a digital model of an appliance. In some embodiments, the physical appliance may be created through a variety of direct formation techniques, such as 3D printing. An appliance can fit over all teeth present in an upper or lower jaw, or less than all of the teeth. The appliance can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance can be a generic appliance configured to receive the teeth, but not necessarily shaped to match the topography of the patient's teeth. In some cases, only certain teeth received by an appliance will be repositioned by the appliance while other teeth can provide a base or anchor region for holding the appliance in place as it applies force against the tooth or teeth targeted for repositioning. In some cases, some or most, and even all, of the teeth will be repositioned at some point during treatment. Teeth that are moved can also serve as a base or anchor for holding the appliance as it is worn by the patient. In some embodiments, no wires or other means will be provided for holding an appliance in place over the teeth. In some cases, however, it may be desirable or necessary to provide individual attachments or other anchoring elements 3304 on teeth 3302 with corresponding receptacles or apertures 3306 in the appliance 3300 so that the appliance can apply a selected force on the tooth. Exemplary appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the URL “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

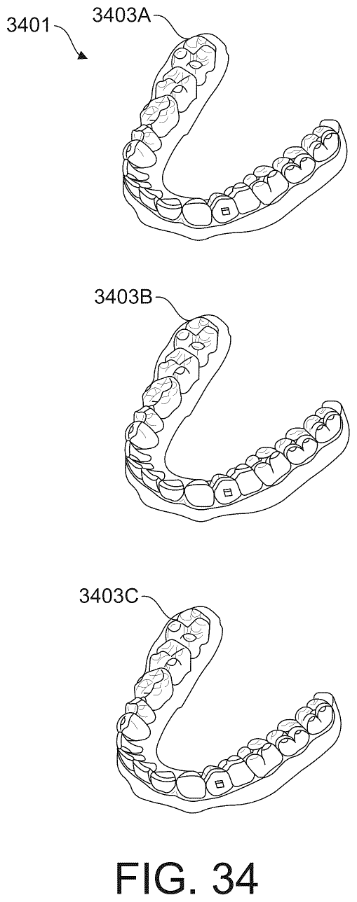

FIG. 34 illustrates a tooth repositioning system 3400 including a plurality of appliances 3403A, 3403B, 3403C. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 3400 can include a first appliance 3403A corresponding to an initial tooth arrangement, one or more intermediate appliances 3403B corresponding to one or more intermediate arrangements, and a final appliance 3403C corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

Optionally, in cases involving more complex movements or treatment plans, it may be beneficial to utilize auxiliary components (e.g., features, accessories, structures, devices, components, and the like) in conjunction with an orthodontic appliance. Examples of such accessories include but are not limited to elastics, wires, springs, bars, arch expanders, palatal expanders, twin blocks, occlusal blocks, bite ramps, mandibular advancement splints, bite plates, pontics, hooks, brackets, headgear tubes, springs, bumper tubes, palatal bars, frameworks, pin-and-tube apparatuses, buccal shields, buccinator bows, wire shields, lingual flanges and pads, lip pads or bumpers, protrusions, divots, and the like. In some embodiments, the appliances, systems and methods described herein include improved orthodontic appliances with integrally formed features that are shaped to couple to such auxiliary components, or that replace such auxiliary components.

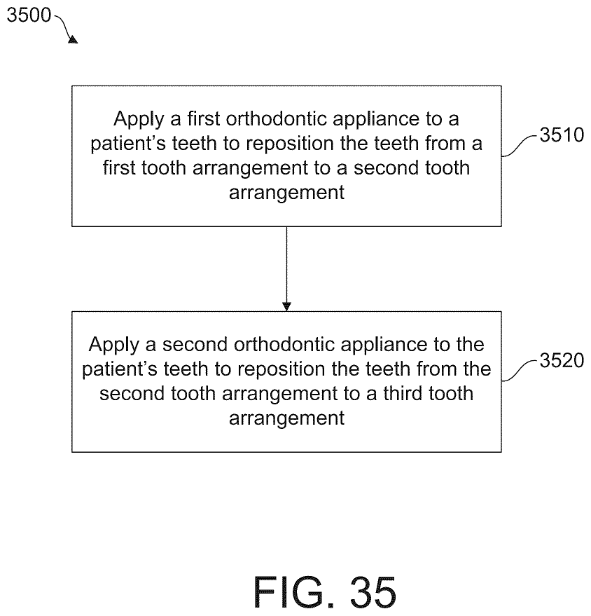

FIG. 35 illustrates a method 3500 of orthodontic treatment using a plurality of appliances, in accordance with many embodiments. The method 3500 can be practiced using any of the appliances or appliance sets described herein. In step 3510, a first orthodontic appliance is applied to a patient's teeth in order to reposition the teeth from a first tooth arrangement to a second tooth arrangement. In step 3520, a second orthodontic appliance is applied to the patient's teeth in order to reposition the teeth from the second tooth arrangement to a third tooth arrangement. The method 3500 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

The relationship between the jaws, maxilla and mandible, may also be adjusted. For example, occlusal blocks may apply mandibular repositioning forces between the maxilla and the mandible to reposition the mandible over one or more mandibular repositioning stages from a first position towards a final position. For example, an first and a second engagement region of a first pair of appliances may be configured to generated mandibular repositioning forces to reposition the mandible from a first position towards a second position in a first stage of treatment and third and fourth engagement regions of a second pair of appliances may be configured to generate second repositions forces to advance the jaw from a position, such as a second position, towards a third position according to a second stage of the treatment plan.

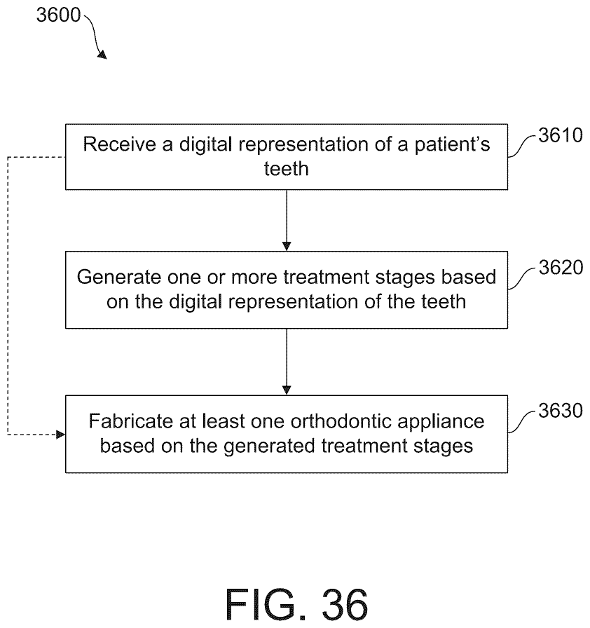

FIG. 36 illustrates a method 3600 for digitally planning an orthodontic treatment and/or design or fabrication of an appliance, in accordance with many embodiments. The method 3600 can be applied to any of the treatment procedures described herein and can be performed by any suitable data processing system. Any embodiment of the appliances described herein can be designed or fabricated using the method 3600.

In step 3610, a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In step 3620, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

A digital model of an appliance having the features described herein may be generated based on the treatment stages. Generating a digital model of an appliance may include identifying a first plurality of teeth on the first jaw and a second first plurality of teeth on the second jaw. The process may also include identifying a first occlusal surface of the first plurality of teeth and a second occlusal surface of the second plurality of teeth. For example, in FIG. 2A the occlusal surface of the teeth 202 may be identified. Although discussed as actual teeth in FIG. 2A and the other figures described herein may also depict digital models of teeth, dentition, aligners, and occlusal blocks.

A geometry of the occlusal blocks and/or their supports may be generated based on the occlusal surfaces of the teeth over which they are placed, such as to match the occlusal surfaces. The appliance engagement region or engagement surfaces may be generated based on the shape of the patient's teeth, the relationship between the arches. The engagement regions of respective blocks may be generated with shapes or geometry such that the physical appliances, when worn by a patient, are configured to engage with each other to apply repositioning forces for the jaws of the patient.

In step 3630, at least one orthodontic appliance is fabricated based on the generated treatment stages. For example, instructions, generated based on the shape of the appliances and having any of the shapes and features described herein, may be provided for 3D printing one or more pairs of dental appliances, each pair for a stage of treatment. A first pair may be generated for a first stage of treatment and a second pair may be generated for a second stage of treatment. For example, a set of appliances can be fabricated to be sequentially worn by the patient to incrementally reposition the teeth from the initial arrangement to the target arrangement. Some of the appliances can be shaped to accommodate a tooth arrangement specified by one of the treatment stages. Alternatively or in combination, some of the appliances can be shaped to accommodate a tooth arrangement that is different from the target arrangement for the corresponding treatment stage. For example, as previously described herein, an appliance may have a geometry corresponding to an overcorrected tooth arrangement. Such an appliance may be used to ensure that a suitable amount of force is expressed on the teeth as they approach or attain their desired target positions for the treatment stage. As another example, an appliance can be designed in order to apply a specified force system on the teeth and may not have a geometry corresponding to any current or planned arrangement of the patient's teeth.

In some instances, staging of various arrangements or treatment stages may not be necessary for design and/or fabrication of an appliance. As illustrated by the dashed line in FIG. 36, design and/or fabrication of an orthodontic appliance, and perhaps a particular orthodontic treatment, may include use of a representation of the patient's teeth (e.g., receive a digital representation of the patient's teeth 3610), followed by design and/or fabrication of an orthodontic appliance based on a representation of the patient's teeth in the arrangement represented by the received representation.

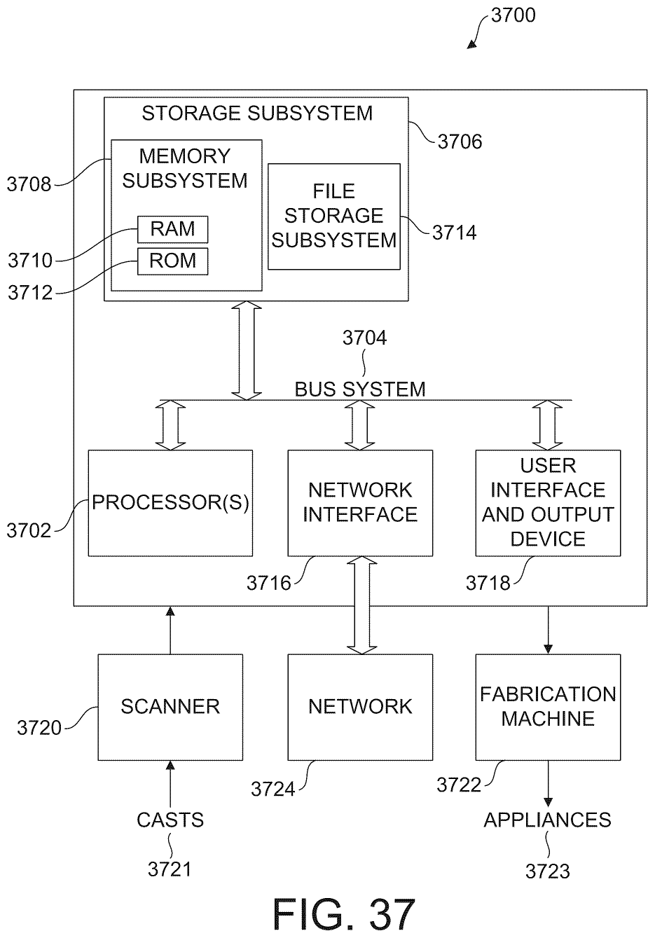

FIG. 37 is a simplified block diagram of a data processing system 3700 that may be used in executing methods and processes described herein. The data processing system 3700 typically includes at least one processor 3702 that communicates with one or more peripheral devices via bus subsystem 3704. These peripheral devices typically include a storage subsystem 3706 (memory subsystem 3708 and file storage subsystem 3714), a set of user interface input and output devices 3718, and an interface to outside networks 3716. This interface is shown schematically as “Network Interface” block 3716, and is coupled to corresponding interface devices in other data processing systems via communication network interface 3724. Data processing system 3700 can include, for example, one or more computers, such as a personal computer, workstation, mainframe, laptop, and the like.

The user interface input devices 3718 are not limited to any particular device, and can typically include, for example, a keyboard, pointing device, mouse, scanner, interactive displays, touchpad, joysticks, etc. Similarly, various user interface output devices can be employed in a system of the invention, and can include, for example, one or more of a printer, display (e.g., visual, non-visual) system/subsystem, controller, projection device, audio output, and the like.

Storage subsystem 3706 maintains the basic required programming, including computer readable media having instructions (e.g., operating instructions, etc.), and data constructs. The program modules discussed herein are typically stored in storage subsystem 3706. Storage subsystem 3706 typically includes memory subsystem 3708 and file storage subsystem 3714. Memory subsystem 3708 typically includes a number of memories (e.g., RAM 3710, ROM 3712, etc.) including computer readable memory for storage of fixed instructions, instructions and data during program execution, basic input/output system, etc. File storage subsystem 3714 provides persistent (non-volatile) storage for program and data files, and can include one or more removable or fixed drives or media, hard disk, floppy disk, CD-ROM, DVD, optical drives, and the like. One or more of the storage systems, drives, etc. may be located at a remote location, such coupled via a server on a network or via the internet/World Wide Web. In this context, the term “bus subsystem” is used generically so as to include any mechanism for letting the various components and subsystems communicate with each other as intended and can include a variety of suitable components/systems that would be known or recognized as suitable for use therein. It will be recognized that various components of the system can be, but need not necessarily be at the same physical location, but could be connected via various local-area or wide-area network media, transmission systems, etc.

Scanner 3720 includes any means for obtaining a digital representation (e.g., images, surface topography data, etc.) of a patient's teeth (e.g., by scanning physical models of the teeth such as casts 3721, by scanning impressions taken of the teeth, or by directly scanning the intraoral cavity), which can be obtained either from the patient or from treating professional, such as an orthodontist, and includes means of providing the digital representation to data processing system 3700 for further processing. Scanner 3720 may be located at a location remote with respect to other components of the system and can communicate image data and/or information to data processing system 3700, for example, via a network interface 3724. Fabrication system 3722 fabricates appliances 3723 based on a treatment plan, including data set information received from data processing system 3700. Fabrication machine 3722 can, for example, be located at a remote location and receive data set information from data processing system 3700 via network interface 3724.

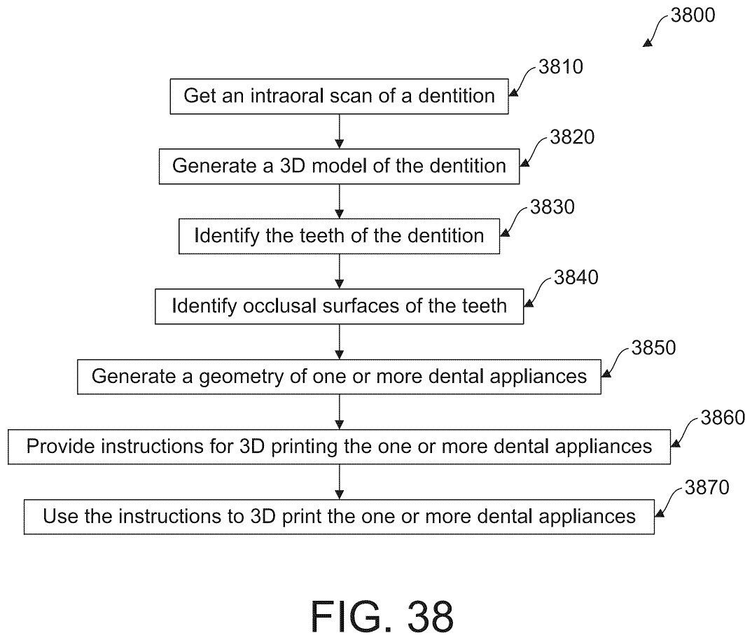

FIG. 38 depicts a method 3800 for orthodontic treatment. The method may include getting an intraoral scan of a dentition at block 3810, generating a model of the dentition at block 3820, identifying teeth of the dentition at block 3830, identifying occlusal surfaces of the teeth at block 3840, generating a geometry of one or more dental appliances at block 3850, providing instructions for 3D printing the one or more dental appliances at block 3860, and using the instructions of 3D print one or more dental appliances at block 3870.

At block 3810, an intraoral scan of the dentition may be generated or retrieved. The scan may be a 3D scan generated using an intraoral scanner or other device as described herein. The scan may include 3D scan data of the upper arch, including the teeth and gingiva, and the lower arch, including the teeth and gingiva.

At block 3820, a 3D model of the patient's dentition may be generated based on the scan. For example, the 3D scan data may be registered together to form a 3D model of the patient's dentition or as otherwise described herein. The 3D model may include the teeth of the upper and lower arches. The teeth may be segmented such that each individual tooth is separated within the model from each other tooth. The 3D model may be a 3D surface model of the patient's dentition, such that the 3D model defines the location and shape of the surfaces of the patient's teeth and gingiva of the upper and lower arches.

At block 3830, teeth of the first jaw and teeth of the second jaw may be identified. For example, a treatment plan may include the addition of occlusal blocks to one or more aligners. The teeth over which the occlusal block are placed may be identified or selected based on the location of the occlusal block or blocks for a stage of treatment.

At block 3840, occlusal surfaces of teeth of the first jaw and of teeth of the second jaw may be identified. For example, the occlusal surfaces of the teeth over which the occlusal block are placed may be identified or selected based on the location of the occlusal block or blocks for a stage of treatment. The surfaces may be selected based on, for example, how much of the occlusal surfaces are to contact the occlusal block or how much of the surface of the occlusal block is configured to match a corresponding surface of the teeth.

At block 3850, a shape of a first geometry of a first dental appliance including a first 3D printed occlusal block is identified or generated. The first geometry of the first dental appliance including a first 3D printed occlusal block may include a first occlusal region shaped to engage with a first plurality of teeth shaped to match a first occlusal surface teeth, and a first appliance engagement region that is located opposite the first occlusal region. The first geometry of the first appliance may have any of the features of the appliances and blocks discussed herein. A shape of a second geometry of a second dental appliance including a second 3D printed occlusal block is identified or generated. The second geometry of the second dental appliance including the second 3D printed occlusal block may include a second occlusal region shaped to engage with a second plurality of teeth shaped to match a second occlusal surface teeth, and a second appliance engagement region that is located opposite the second occlusal region. The second geometry of the second appliance may have any of the features of the appliances and blocks discussed herein.

The first appliance engagement regions may be configured to engage the second appliance engagement regions to generate mandibular repositioning forces toward the first jaw and the second jaw, as described herein.

At block 3860 instructions for 3D printing the one or more dental appliances may be generated and/or provided. For example, instructions, generated based on the geometry of the appliances and having any of the shapes and features described herein, may be provided for 3D printing one or more pairs of dental appliances, each pair for a stage of treatment. A first pair may be generated for a first stage of treatment and a second pair may be generated for a second stage of treatment. For example, a set of appliances can be fabricated to be sequentially worn by the patient to incrementally reposition the teeth and/or jaw from the initial arrangement to the target arrangement. Some of the appliances can be shaped to accommodate a tooth arrangement specified by one of the treatment stages.

At block 3870 the one or more dental appliances may be fabricated using the instructions. For example, at least one orthodontic appliance may be fabricated based on the generated treatment stages. For example, instructions, generated based on the shape of the appliances and having any of the shapes and features described herein, may be provided for 3D printing one or more pairs of dental appliances, each pair for a stage of treatment. A first pair may be generated for a first stage of treatment and a second pair may be generated for a second stage of treatment. For example, a set of appliances can be fabricated to be sequentially worn by the patient to incrementally reposition the teeth from the initial arrangement to the target arrangement.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and shall have the same meaning as the word “comprising”.

It will be understood that although the terms “first,” “second,” “third”, etc. may be used herein to describe various layers, elements, components, regions or sections without referring to any particular order or sequence of events. These terms are merely used to distinguish one layer, element, component, region or section from another layer, element, component, region or section. A first layer, element, component, region or section as described herein could be referred to as a second layer, element, component, region or section without departing from the teachings of the present disclosure.

As used herein, the term “or” is used inclusively to refer items in the alternative and in combination, unless indicated otherwise.

As used herein, characters such as numerals refer to like elements.

Embodiments of the present disclosure have been shown and described as set forth herein and are provided by way of example only. One of ordinary skill in the art will recognize numerous adaptations, changes, variations and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

The disclosure includes the following clauses and embodiments:

Clause 1. An orthodontic treatment system comprising: a plurality of sets of polymeric orthodontic appliances, each of the orthodontic appliances including a plurality of tooth receiving cavities formed in the appliance shaped to move teeth of a patient from a first arrangement towards a second arrangement, each of the sets of polymeric appliances for a stage of orthodontic treatment; a first occlusal block on a first appliance of a first set of the plurality of sets; and a second occlusal block on a second appliance of the first set; wherein the first appliance is configured for use on a first arch of the patient and the second appliance is configured for use on a second, opposing, arch of the patient and wherein each of the first and second occlusal blocks incudes a first surface having a first shape that matches an occlusal surface of the arch on which the appliance is configured to be placed.

Clause 2. The orthodontic treatment system of clause 1, wherein the first surface includes an extension configured to extend into a gap between two non-adjacent teeth.

Clause 3. The orthodontic treatment system of clause 2, wherein a distal surface of the extension includes a shape to match a shape of a tooth erupting between the two non-adjacent teeth.

Clause 4. The orthodontic treatment system of clause 2, wherein the extension is configured to apply an expansion force to the two non-adjacent teeth to move the two non-adjacent teeth away from each other.

Clause 5. The orthodontic treatment system of clause 1, wherein the first surface is shaped to extend into an interproximal region between two adjacent teeth.

Clause 6. The orthodontic treatment system of clause 1, wherein the first surface is shaped to match a shape of tooth cusps of the teeth.

Clause 7. The orthodontic treatment system of clause 1, wherein the first surface is shaped to extend into grooves between tooth cusps.

Clause 8. The orthodontic treatment system of clause 1, wherein the first and second appliances include a transition zone to transition a thickness of the appliance between a tooth receiving cavity surface of the respective appliance and the occlusal block of the respective appliance.

Clause 9. The orthodontic treatment system of clause 8, wherein the transition zone is between an engagement surface of the respective occlusal blocks and an occlusal surface of a tooth receiving cavity.

Clause 10. The orthodontic treatment system of clause 8, wherein the transition zone is between an engagement surface of the respective occlusal blocks and a sidewall surface of a tooth receiving cavity.

Clause 11. The orthodontic treatment system of clause 1, wherein the first arch and the second arch are in a crossbite malocclusion and a lingual side of the first occlusal block extends lingually beyond a lingual sidewall of the first appliance.

Clause 12. The orthodontic treatment system of clause 11, wherein a lingual side of the first occlusal block extends beyond an occlusal surface of the second appliance.

Clause 13. The orthodontic treatment system of clause 11, wherein a buccal side of the first occlusal block extends buccally beyond a buccal sidewall of the first appliance.

Clause 14. The orthodontic treatment system of clause 1, wherein the first occlusal block includes a first occlusal block cavity and a first occlusal block support is shaped to fill the first occlusal block cavity.

Clause 15. The orthodontic treatment system of clause 14, wherein the first surface is a lower surface of the first occlusal block support.

Clause 16. The orthodontic treatment system of clause 14, wherein an upper surface of the occlusal block support is configured to extend into an interproximal region between two teeth of an opposing arch.

Clause 17. The orthodontic treatment system of clause 1, wherein the first occlusal block is a posterior occlusal block of the first appliance of the set of appliances and wherein the first appliance of the set of appliances includes a first anterior occlusal block having a distal surface shaped to engage with the second appliance of the set of appliances.

Clause 18. The orthodontic treatment system of clause 17, wherein the second occlusal block is a posterior occlusal block of the second appliance of the set of appliances and wherein the second appliance of the set of appliances includes a second anterior occlusal block having a distal surface shaped to engage with the second appliance of the set of appliances.

Clause 19. The orthodontic treatment system of clause 18, wherein the distal surface of the first anterior occlusal block is shaped to engage with the distal surface of the second anterior occlusal block.

Clause 20. The orthodontic treatment system of clause 1, wherein the first surface includes an attachment receiving cavity shaped to receive and apply orthodontic movement forces to an attachment on an occlusal surface of the teeth.

Clause 21. The orthodontic treatment system of clause 14, further comprising retention features extending into the first occlusal block cavity from an inner sidewall of the first occlusal block cavity.

Clause 22. The orthodontic treatment system of clause 21, wherein the retention features extend into the first occlusal block cavity at least 10% of a width of the first occlusal block cavity.

Clause 23. The orthodontic treatment system of clause 21, wherein the retention features form an undercut within the first occlusal block cavity.

Clause 24. The orthodontic treatment system of clause 21, wherein the retention features extend across the first occlusal block cavity from a buccal sidewall to a lingual sidewall.

Clause 25. The orthodontic treatment system of clause 1, wherein the first and second occlusal blocks include a first button extending from a respective external surface, the button configured to engage with an elastic configured to extend to a second button.

Clause 26. The orthodontic treatment system of clause 25, wherein the first and second occlusal blocks include a first button extending from a respective external surface, the first button configured to engage with an elastic configured to extend to a second button.

Clause 27. The orthodontic treatment system of clause 26, wherein the second button is the first button of an appliance on an opposing arch.

Clause 28. The orthodontic treatment system of clause 26, wherein the second button is configured to be attached to a tooth of the patient over which the first occlusal block is configured to extend.

Clause 29. The orthodontic treatment system of clause 1, wherein the occlusal surfaces of the occlusal blocks are inclined in a buccal-lingual direction with respect to an occlusal plane of the arches to provide buccal-lingual alignment guidance when worn by the patient.

Clause 30. The orthodontic treatment system of clause 1, wherein the occlusal blocks include an occlusal block support structure in the form of an arch.

Clause 31. The orthodontic treatment system of clause 30, wherein sides of the arch form sidewalls of the occlusal block.

Clause 32. The orthodontic treatment system of clause 31, wherein a base of the sides of the arch are shaped to engage with a respective occlusal surface of a respective tooth.

Clause 33. The orthodontic treatment system of clause 32, wherein the base of the sides of the arch have first thickness that are greater than a second thickness of an apex of the respective arches.

Clause 34. The orthodontic treatment system of clause 33, wherein the apex of the arches form a respective occlusal surface of the respective occlusal block.

Clause 35. The orthodontic treatment system of clause 1, wherein the occlusal blocks include respective occlusal block cavities.

Clause 36. The orthodontic treatment system of clause 35, further comprising one or more ribs within each respective occlusal block cavity.

Clause 37. The orthodontic treatment system of clause 36, wherein the ribs extend from an upper internal surface of each respective occlusal block cavity.

Clause 38. The orthodontic treatment system of clause 37, wherein each rib includes a lower surface shaped to match an occlusal surface of a tooth over which the occlusal block is configured to be placed when worn by a patient.

Clause 39. The orthodontic treatment system of clause 35, wherein sidewalls of the occlusal block cavity are configured to engage with an occlusal surface of a tooth over which the occlusal block is configured to be placed when worn by a patient.

Clause 40. The orthodontic treatment system of clause 1, further comprising a living hinge at a base of the first occlusal block.

Clause 41. The orthodontic treatment system of clause 40, further comprising a living hinge at a base of a sidewall of the first occlusal block.

Clause 42. The orthodontic treatment system of clause 40, further comprising a living hinge in a wall of a tooth receiving cavity of the first appliance.

Clause 43. The orthodontic treatment system of clause 40, wherein the living hinge comprises a plurality of channels.

Clause 44. The orthodontic treatment system of clause 40, wherein the living hinge comprises a plurality of apertures.

Clause 45. An orthodontic treatment system comprising: a plurality of sets of polymeric orthodontic appliances, each of the polymeric orthodontic appliance including a plurality of tooth receiving cavities formed in the appliance shaped to move teeth of a patient from a first arrangement towards a second arrangement, each of the sets of polymeric appliances for a stage of orthodontic treatment; a first wing extending from a side of a first appliance of a first set of the plurality of sets; and one or more aligner features stacked with the first wing.

Clause 46. The orthodontic treatment system of clause 45, wherein the wing extends from a sidewall of the first appliance.

Clause 47. The orthodontic treatment system of clause 45, wherein the one or more aligner features stacked with the first wing are formed within the wing.

Clause 48. The orthodontic treatment system of clause 45, wherein the one or more aligner features stacked with the first wing includes a compliance indicators within a body of the wing.

Clause 49. The orthodontic treatment system of clause 45, wherein the one or more aligner features stacked with the first wing includes an attachment receiving cavity formed at a base of the wing.

Clause 50. The orthodontic treatment system of clause 45, further comprising a first occlusal block on the first appliance, wherein the wing extends from a side of the first occlusal block.

Clause 51. The orthodontic treatment system of clause 50, wherein the first appliance is configured to be worn on a first arch of the patient, and wherein an occlusal surface of the first occlusal block is shaped to match the occlusal surface of an opposing arch and a lower surface of the occlusal block is shaped to match the occlusal surface of the first arch.

Clause 52. A dental appliance system comprising: a first dental appliance including a first three-dimensionally (3D) printed occlusal block having: a first occlusal region shaped to engage with a first plurality of teeth on a first jaw and shaped to match a first occlusal surface of the first plurality of teeth, and a first appliance engagement region opposite the first occlusal region; a second dental appliance including a second 3D printed occlusal block having: a second occlusal region shaped to engage with a second plurality of teeth on a second jaw opposite the first jaw, and a second appliance engagement region opposite the second occlusal region; wherein the first appliance engagement region engages the second appliance engagement region to deliver mandibular repositioning forces toward the first jaw and the second jaw.

Clause 53. The dental appliance system of clause 52, wherein the first 3D printed occlusal block is incorporated as part of an aligner.

Clause 54. The dental appliance system of clause 52, wherein the first 3D printed occlusal block is incorporated as part of twin block mandibular repositioning system.

Clause 55. The dental appliance system of clause 52, wherein the first appliance engagement region and the second appliance engagement region are angled to deliver the mandibular repositioning forces toward the first jaw and the second jaw.

Clause 56. The dental appliance system of clause 52, wherein the first 3D printed block is distinct from the second 3D printed block.

Clause 57. The dental appliance system of clause 52, wherein the second occlusal region is shaped to match a second occlusal surface of the second plurality of teeth.

Clause 58. The dental appliance system of clause 52, wherein the first plurality of teeth comprises a first plurality of posterior teeth, the second plurality of teeth comprises a second plurality of posterior teeth, or some combination thereof.

Clause 59. The dental appliance system of clause 52, wherein the first 3D printed occlusal block comprises a first intercuspal region shaped to match the second occlusal surface on the second plurality of teeth, an occlusal surface of an aligner on the second plurality of teeth, or some combination thereof.

Clause 60. The dental appliance system of clause 52, wherein the first 3D printed occlusal block comprises a first intercuspal region shaped to match the second occlusal surface on the second plurality of teeth, an occlusal surface of an aligner on the second plurality of teeth, or some combination thereof, wherein the first intercuspal region is adjacent to the first appliance engagement region.

Clause 61. The dental appliance system of clause 60, wherein the second 3D printed occlusal block comprises a second intercuspal region shaped to match the first occlusal surface on the first plurality of teeth, an occlusal surface of an aligner on the first plurality of teeth, or some combination thereof.

Clause 62. The dental appliance system of clause 61, wherein the second 3D printed occlusal block comprises a second intercuspal region shaped to match the first occlusal surface on the first plurality of teeth, an occlusal surface of an aligner on the first plurality of teeth, or some combination thereof, and wherein the second intercuspal region is adjacent to the second appliance engagement region.

Clause 63. The dental appliance system of clause 60, wherein the first occlusal region transitions to the first intercuspal region.

Clause 64. The dental appliance system of clause 52, wherein the first 3D printed occlusal block, the second 3D printed block, or some combination thereof, comprise infilled regions.

Clause 65. The dental appliance system of clause 64, wherein the infilled regions are associated with interproximal areas of the first plurality of teeth, the second plurality of teeth, or some combination thereof.

Clause 66. The dental appliance system of clause 52, wherein the first 3D printed occlusal block, the second 3D printed block, or some combination thereof are arranged to accommodate missing teeth, erupting teeth, or some combination thereof.

Clause 67. The dental appliance system of clause 52, wherein the first 3D printed occlusal block, the second 3D printed block, or some combination thereof are arranged to accommodate one or more aligner attachments bonded on the first plurality of teeth, the second plurality of teeth, or some combination thereof, wherein the one or more aligner attachments are shaped to engage with one or more aligners, and when coupled to a well of the one or more aligners, implement force systems on the first plurality of teeth, the second plurality of teeth, or some combination thereof.

Clause 68. The dental appliance system of clause 52, wherein the first 3D printed occlusal block, the second 3D printed block, or some combination thereof are additively manufactured into one or more 3D printed aligners.

Clause 69. The dental appliance system of clause 52, wherein the first 3D printed occlusal block, the second 3D printed block, or some combination thereof are inserted into one or more thermoformed aligners.

Clause 70. The dental appliance system of clause 52, wherein the first 3D printed occlusal block, the second 3D printed block, or some combination comprise a plurality of additively formed material layers.

Clause 71. The dental appliance system of clause 70, wherein the plurality additively formed material layers comprise a plurality of additively formed polymer layers.

Clause 72. A dental appliance system comprising: a first pair of dental appliances to implement a first stage of a treatment plan, the first pair of dental appliances comprising: a first three-dimensionally (3D) printed occlusal block including: a first occlusal region shaped to engage with a first plurality of teeth on a first jaw and shaped to match a first occlusal surface of the first plurality of teeth, and a first appliance engagement region opposite the first occlusal region; a second 3D printed occlusal block including: a second occlusal region shaped to engage with a second plurality of teeth on a second jaw opposite the first jaw, and a second appliance engagement region opposite the second occlusal region; wherein the first appliance engagement region engages the second appliance engagement region to deliver mandibular repositioning forces toward the first jaw and the second jaw in accordance with the first stage of the treatment plan; and a second pair of dental appliances to implement a second stage of a treatment plan, the second pair of dental appliances comprising: a third three-dimensionally (3D) printed occlusal block including: a third occlusal region shaped to engage with the first plurality of teeth on the first jaw and shaped to match the first occlusal surface of the first plurality of teeth, and a third appliance engagement region opposite the third occlusal region; a fourth 3D printed occlusal block including: a fourth occlusal region shaped to engage with a second plurality of teeth on a second jaw opposite the first jaw, and a fourth appliance engagement region opposite the fourth occlusal region; wherein the third appliance engagement region engages the fourth appliance engagement region to deliver mandibular repositioning forces toward the first jaw and the second jaw in accordance with the second stage of the treatment plan.

Clause 73. A dental appliance system comprising: a first dental appliance including: a three-dimensionally (3D) printed occlusal block having: a first occlusal region shaped to engage with a first plurality of teeth on a first jaw, a first appliance engagement region opposite the first occlusal region; and a first 3D printed anterior contact block; a second dental appliance including a 3D printed occlusal block having: a second occlusal region shaped to engage with a second plurality of teeth on a second jaw opposite the first jaw, a second appliance engagement region opposite the second occlusal region, and a second 3D printed anterior contact block shaped to engage the first 3D printed anterior block; wherein the first appliance engagement region engages the second appliance engagement region to deliver mandibular repositioning forces toward the first jaw and the second jaw; and wherein, when the first 3D printed anterior block and the second 3D printed anterior block are engaged, one or more intrusion forces on the first plurality of teeth and the second plurality of teeth are reduced.

Clause 74. A method comprising: getting an intraoral scan of a patient's dentition comprising a first jaw and a second jaw; generating a three-dimensional model of the patient's dentition using the intraoral scan; identifying a first plurality of teeth on the first jaw and a second first plurality of teeth on the second jaw; identifying a first occlusal surface of the first plurality of teeth and a second occlusal surface of the second plurality of teeth; identifying: a first geometry of a first dental appliance including a first 3D printed occlusal block having: a first occlusal region shaped to engage with the first plurality of teeth shaped to match the first occlusal surface teeth, and a first appliance engagement region opposite the first occlusal region; a second geometry of a second dental appliance including a second 3D printed occlusal block having: a second occlusal region shaped to engage with the second plurality of teeth, and a second appliance engagement region opposite the second occlusal region; wherein the first appliance engagement region engages the second appliance engagement region to deliver mandibular repositioning forces toward the first jaw and the second jaw; providing instructions to 3D print the first dental appliance, the second dental appliance, or some combination thereof; using the instructions to 3D printing the first dental appliance, the second dental appliance, or some combination thereof.

Clause 75. An orthodontic treatment system comprising: a polymeric orthodontic appliance; a plurality of tooth receiving cavities formed in the appliance shaped to move teeth of a patient from a first arrangement towards a second arrangement, for a stage of orthodontic treatment; a first wing extending from a side of the polymeric orthodontic appliance; and one or more aligner features stacked with the first wing.

Clause 76. An orthodontic treatment system comprising: a first polymeric orthodontic appliance comprising a plurality of tooth receiving cavities formed in the appliance shaped to move teeth of a first arch of a patient from a first arrangement towards a second arrangement, for a stage of orthodontic treatment; a second polymeric orthodontic appliance comprising a plurality of tooth receiving cavities formed in the appliance shaped to move teeth of a second arch of the patient from a first arrangement towards a second arrangement, for the stage of orthodontic treatment; a first wing extending from a side of the first polymeric orthodontic appliance; an outer surface of the first wing shaped to match a profile of a side of the first polymeric appliance.

Clause 77. An orthodontic treatment system comprising: a polymeric orthodontic appliance; a plurality of tooth receiving cavities formed in the appliance shaped to move teeth of a patient from a first arrangement towards a second arrangement, for a stage of orthodontic treatment; a first wing extending from a side of the polymeric orthodontic appliance, wherein the first wing includes a hinge configured to allow greater deflection in a superior-inferior direction than in an anterior-posterior direction.

Clause 78. An orthodontic treatment system comprising: a first polymeric orthodontic appliance comprising a plurality of tooth receiving cavities formed in the appliance shaped to move teeth of a first arch of a patient from a first arrangement towards a second arrangement, for a stage of orthodontic treatment; a second polymeric orthodontic appliance comprising a plurality of tooth receiving cavities formed in the appliance shaped to move teeth of a second arch of the patient from a first arrangement towards a second arrangement, for the stage of orthodontic treatment; a first wing extending from a side of the first polymeric orthodontic appliance and include a first coupling; a second wing extending from a side of the second polymeric orthodontic appliance and include a second coupling configured to engage with the first coupling when the first are and second arch are in occlusion.

Clause 79. An orthodontic treatment system comprising: a plurality of sets of polymeric orthodontic appliances, each of the polymeric orthodontic appliance including a plurality of tooth receiving cavities formed in the appliance shaped to move teeth of a patient from a first arrangement towards a second arrangement, each of the sets of polymeric appliances for a stage of orthodontic treatment; a first wing extending from a side of a first appliance of a first set of the plurality of sets; and a compliance indicator stacked within the first wing.

Clause 80. An orthodontic treatment system comprising: a pair of polymeric orthodontic appliances, each of the orthodontic appliances including a plurality of tooth receiving cavities formed in the appliance shaped to move teeth of a patient from a first arrangement towards a second arrangement, each of the orthodontic appliances for a stage of orthodontic treatment; a first occlusal block on a first appliance of a first of the pair of appliances; and a second occlusal block on a second appliance of the pair of appliances; wherein the first appliance is configured for use on a first arch of the patient and the second appliance is configured for use on a second, opposing, arch of the patient and wherein the first and second occlusal blocks include a first button extending from a respective external surface, the first button for the first occlusal block configured to engage with an elastic configured to extend to the first button of the second occlusal block

Clause 81. An orthodontic treatment system comprising: a pair of polymeric orthodontic appliances, each of the orthodontic appliances including a plurality of tooth receiving cavities formed in the appliance shaped to move teeth of a patient from a first arrangement towards a second arrangement, each of the orthodontic appliances for a stage of orthodontic treatment; a first occlusal block on a first appliance of a first of the pair of appliances; a first button located on the first occlusal block; and a second button located on a tooth receiving cavity and configured to receive an elastic that extends between the first button and the second button.

Clause 82. An orthodontic treatment system comprising: a pair of polymeric orthodontic appliances, each of the orthodontic appliances including a plurality of tooth receiving cavities formed in the appliance shaped to move teeth of a patient from a first arrangement towards a second arrangement, each of the orthodontic appliances for a stage of orthodontic treatment; a first occlusal block on a first appliance of a first of the pair of appliances including a first surface having a first shape that matches an occlusal surface of the arch on which the appliance is configured to be placed, wherein the first surface includes an extension configured to extend into a gap between two non-adjacent teeth and to apply an expansion force to the two non-adjacent teeth to move the two non-adjacent teeth away from each other to maintain the gap or enlarge the gap.

Clause 83. An orthodontic treatment system comprising: a pair of polymeric orthodontic appliances, each of the orthodontic appliances including a plurality of tooth receiving cavities formed in the appliance shaped to move teeth of a patient from a first arrangement towards a second arrangement, each of the orthodontic appliances for a stage of orthodontic treatment; a first occlusal block on first side of a first appliance of the pair of appliances; a second occlusal block on second side of a first appliance of the pair of appliances; a third occlusal block on first side of a second appliance of the pair of appliances; a fourth occlusal block on second side of a second appliance of the pair of appliances, wherein the first and second occlusal blocks includes upper surfaces shaped to engage a respective one of the third and fourth occlusal blocks at an angle with respect to the occlusal plane to provide buccal-lingual alignment guidance when worn by the patient.

Clause 84. An orthodontic treatment system comprising: a polymeric orthodontic appliance; a plurality of tooth receiving cavities formed in the appliance shaped to move teeth of a patient from a first arrangement towards a second arrangement, for a stage of orthodontic treatment; an occlusal block extending from the appliance, wherein a tooth facing surface of the occlusal block is configured to be spaced a distance away from an occlusal surface of a tooth in an occlusal direction to provide space for the tooth to erupt into; and an attachment receiving well extending from the tooth receiving cavity and configured to impart a force on the attachment to erupt the tooth.

Clause 85. An orthodontic treatment system comprising: a first polymeric orthodontic appliance comprising a plurality of tooth receiving cavities formed in the appliance shaped to move teeth of a first arch of a patient from a first arrangement towards a second arrangement, for a stage of orthodontic treatment; a second polymeric orthodontic appliance comprising a plurality of tooth receiving cavities formed in the appliance shaped to move teeth of a second arch of the patient from a first arrangement towards a second arrangement, for the stage of orthodontic treatment, wherein the teeth of the second arch are displaced in a buccal-lingual direction from the first arch; a first wing extending from a side of the first polymeric orthodontic appliance; and a second wing extending from a side of the first polymeric orthodontic appliance, the second wing including an extension that extends laterally in the buccal-lingual direction the distance before extending in an occlusal direction.

Clause 86. An orthodontic treatment system comprising: a pair of polymeric orthodontic appliances, each of the orthodontic appliances including a plurality of tooth receiving cavities formed in the appliance shaped to move teeth of a patient from a first arrangement towards a second arrangement, each of the orthodontic appliances for a stage of orthodontic treatment, a first appliance of the pair of appliances for a first arch and a second appliance of the pair of appliances for a second arch, wherein teeth of the first arch are in a crossbite malocclusion with teeth of the second arch; a first occlusal block on the first appliance; and a second occlusal block on the second appliance, an occlusal surface of the second block extending laterally beyond a side of a tooth receiving on which the second occlusal block is placed by a distance to account for the cross bite and engage with the first occlusal block.

Clause 87. An orthodontic treatment system comprising: a pair of polymeric orthodontic appliances, each of the orthodontic appliances including a plurality of tooth receiving cavities formed in the appliance shaped to move teeth of a patient from a first arrangement towards a second arrangement, each of the orthodontic appliances for a stage of orthodontic treatment, a first appliance of the pair of appliances for a first arch and a second appliance of the pair of appliances for a second arch, wherein teeth of the first arch are in a crossbite malocclusion with teeth of the second arch; a first occlusal block on the first appliance; and a second occlusal block on the second appliance, wherein the first and second occlusal blocks each include respective occlusal surface shaped to engage with each other and having surface shapes that cooperate with each other to resist mesial-distal movement in a first direction and slide to allow mesial-distal movement in a second direction.

Clause 88. An orthodontic treatment system comprising: a first polymeric orthodontic appliance comprising a plurality of tooth receiving cavities formed in the appliance shaped to move teeth of a first arch of a patient from a first arrangement towards a second arrangement, for a stage of orthodontic treatment; a second polymeric orthodontic appliance comprising a plurality of tooth receiving cavities formed in the appliance shaped to move teeth of a second arch of the patient from a first arrangement towards a second arrangement, for the stage of orthodontic treatment, wherein the teeth of the second arch are displaced in a buccal-lingual direction from the first arch; a first wing extending from a side of the first polymeric orthodontic appliance; and a second wing extending from a side of the first polymeric orthodontic appliance and configured to engage with the first wing when the upper arch and lower arch come into occlusion, wherein the first wing has a first length that extends at a first angle and the second wing has a second length that extends at a second angle, the first and second lengths and the first and second angles based on an articulation model of jaws of the patient, the fist and second lengths and angles configured to allow the first and second wings to move past each other during an initial portion of the jaws coming into occlusion and engage with each other as the jaws come into full occlusion.

Clause 89. An orthodontic treatment system comprising: a polymeric orthodontic appliance; a plurality of tooth receiving cavities formed in the appliance shaped to move teeth of a patient from a first arrangement towards a second arrangement, for a stage of orthodontic treatment; an occlusal block extending from the appliance, wherein the occlusal blocks have a cross-sectional shape in the form of an arch wherein sides of the arch form sidewalls of the occlusal block and a base of the sides of the arch are shaped to engage with a respective occlusal surface of a respective tooth and having first thickness that are greater than a second thickness of an apex of the respective arches.

Clause 90. An orthodontic treatment system comprising: a polymeric orthodontic appliance; a plurality of tooth receiving cavities formed in the appliance shaped to move teeth of a patient from a first arrangement towards a second arrangement, for a stage of orthodontic treatment; a first wing extending from a side of the polymeric orthodontic appliance having an enclosed interior cavity with hydrogel and medicine, the sidewall of the wings being semipermeable to allow medicine to move from the cavity into an oral cavity of the patent, the first wing include a flat sidewall portion shaped to receive an aligner auxiliary thereon.

Clause 91. An orthodontic treatment system comprising: a polymeric orthodontic appliance; a plurality of tooth receiving cavities formed in the appliance shaped to move teeth of a patient from a first arrangement towards a second arrangement, for a stage of orthodontic treatment; a first wing extending from a side of the polymeric orthodontic appliance wherein the first wing has a first length that extends at a first angle in a mesial-distal direction about a buccal-lingual axis and one or more ribs formed in a sidewall of the first wing that extend along the length.

Clause 92. An orthodontic treatment system comprising: a polymeric orthodontic appliance; a plurality of tooth receiving cavities formed in the appliance shaped to move teeth of a patient from a first arrangement towards a second arrangement, for a stage of orthodontic treatment; an occlusal block extending from the appliance and having an occlusal block cavity formed therein, the occlusal block comprising one or more ribs within the occlusal block cavity that extend from an upper internal surface the occlusal block cavity, the ribs having a lower surface shaped to match an occlusal surface of a tooth over which the occlusal block is configured to be placed when worn by a patient.

Clause 93. An orthodontic treatment system comprising: a polymeric orthodontic appliance; a plurality of tooth receiving cavities formed in the appliance shaped to move teeth of a patient from a first arrangement towards a second arrangement, for a stage of orthodontic treatment; an occlusal block extending from the appliance comprising a living hinge at a base of the occlusal block.

Clause 94. An orthodontic treatment system comprising: a polymeric orthodontic appliance; a plurality of tooth receiving cavities formed in the appliance shaped to move teeth of a patient from a first arrangement towards a second arrangement, for a stage of orthodontic treatment; an occlusal block extending from the appliance and comprising one or more wings extending from one or more sides of the occlusal block, a surface of each of the one or more wings shaped to match a surface of a tooth or aligner of an opposing arch.

Clause 95. An orthodontic appliance system comprising: a first polymeric orthodontic appliance to implement a mesial-distal correction according to a first stage of an orthodontic treatment plan on a first arch, wherein the first polymeric orthodontic appliance includes a first occlusal block, wherein the first occlusal block has a first surface with a first shape to match a first occlusal surface of the first arch; and a second polymeric orthodontic appliance to implement the mesial-distal correction according to the first stage of an orthodontic treatment plan on a second arch opposing the first arch, wherein the second polymeric orthodontic appliance includes a second occlusal block, wherein the second occlusal block has a second surface with a second shape to match a second occlusal surface of the second arch.

Clause 96. The orthodontic appliance system of clause 95, wherein the first polymeric orthodontic appliance comprises a first plurality of additively formed layers, the second polymeric orthodontic appliance comprises a second plurality of additively formed layers, or some combination thereof.

Clause 97. The orthodontic appliance system of clause 95, wherein: the first stage of the orthodontic treatment plan comprises instructions for the mesial-distal correction and for repositioning teeth in the first arch from a first arrangement toward a second arrangement; the first polymeric orthodontic appliance comprises a first plurality of tooth receiving cavities to reposition the teeth in the first arch from the first arrangement toward the second arrangement in accordance with the first stage of the treatment plan.

Clause 98. The orthodontic appliance system of clause 95, wherein the first polymeric orthodontic appliance comprises a first plurality of tooth receiving cavities to reposition teeth in the first arch from a first arrangement toward a second arrangement; and the first polymeric orthodontic appliance comprises a first plurality of additively formed layers, at least some of the first plurality of additively formed layers being through the first occlusal block and the first plurality of tooth receiving cavities.

Clause 99. An orthodontic appliance system comprising: a first polymeric orthodontic appliance to implement a mesial-distal correction according to a first stage of an orthodontic treatment plan on a first arch, wherein the first polymeric orthodontic appliance includes a first occlusal block, wherein a first surface of the first occlusal block is configured to match a first occlusal surface of the first arch to retain the first occlusal block on the first arch; and a second polymeric orthodontic appliance to implement the mesial-distal correction according to the first stage of an orthodontic treatment plan on a second arch opposing the first arch, wherein the second polymeric orthodontic appliance includes a second occlusal block, wherein a second surface of the second occlusal block is configured to match a second occlusal surface of the second arch to retain the second occlusal block on the second arch.

Clause 100. An orthodontic appliance system comprising: a first polymeric orthodontic appliance to implement a mesial-distal correction according to a first stage of an orthodontic treatment plan on a first arch, wherein the first polymeric orthodontic appliance includes means for matching a first occlusal surface of the first arch to retain the first occlusal block on the first arch; and a second polymeric orthodontic appliance to implement the mesial-distal correction according to the first stage of an orthodontic treatment plan on a second arch opposing the first arch, wherein the second polymeric orthodontic appliance includes means for matching a second occlusal surface of the second arch to retain the second occlusal block on the second arch.

Clause 101. An orthodontic appliance system comprising: a first polymeric orthodontic appliance to implement a mesial-distal correction according to a first stage of an orthodontic treatment plan on a first arch, wherein the first polymeric orthodontic appliance includes a first occlusal block, wherein the first occlusal block has a first surface with a first shape to match a first occlusal surface of the first arch; and a second polymeric orthodontic appliance to implement the mesial-distal correction according to the first stage of an orthodontic treatment plan on a second arch opposing the first arch, wherein the second polymeric orthodontic appliance includes a second occlusal block, at least a portion of the second occlusal block shaped to engage with the first occlusal block to implement the mesial-distal correction.

1. An orthodontic treatment system comprising:
a plurality of sets of polymeric orthodontic appliances, each of the orthodontic appliances including a plurality of tooth receiving cavities formed in the appliance shaped to move teeth of a patient from a first arrangement towards a second arrangement, each of the sets of polymeric appliances for a stage of orthodontic treatment;
a first occlusal block on a first appliance of a first set of the plurality of sets; and
a second occlusal block on a second appliance of the first set;
wherein the first appliance is configured for use on a first arch of the patient and the second appliance is configured for use on a second, opposing, arch of the patient and wherein each of the first and second occlusal blocks incudes a first surface having a first shape that matches an occlusal surface of the arch on which the appliance is configured to be placed.

2. The orthodontic treatment system of claim 1, wherein the first surface includes an extension configured to extend into a gap between two non-adjacent teeth.

3. The orthodontic treatment system of claim 1, wherein the first surface is shaped to extend into an interproximal region between two adjacent teeth.

4. The orthodontic treatment system of claim 1, wherein the first surface is shaped to extend into grooves between tooth cusps.

5. The orthodontic treatment system of claim 1, wherein the first and second appliances include a transition zone to transition a thickness of the appliance between a tooth receiving cavity surface of the respective appliance and the occlusal block of the respective appliance.

6. The orthodontic treatment system of claim 5, wherein the transition zone is between an engagement surface of the respective occlusal blocks and an occlusal surface of a tooth receiving cavity.

7. The orthodontic treatment system of claim 1, wherein the first arch and the second arch are in a crossbite malocclusion and a lingual side of the first occlusal block extends lingually beyond a lingual sidewall of the first appliance.

8. The orthodontic treatment system of claim 7, wherein a lingual side of the first occlusal block extends beyond an occlusal surface of the second appliance.

9. The orthodontic treatment system of claim 7, wherein a buccal side of the first occlusal block extends buccally beyond a buccal sidewall of the first appliance.

10. The orthodontic treatment system of claim 1, wherein the first occlusal block includes a first occlusal block cavity and a first occlusal block support is shaped to fill the first occlusal block cavity.

11. The orthodontic treatment system of claim 10, wherein the first surface is a lower surface of the first occlusal block support.

12. The orthodontic treatment system of claim 10, wherein an upper surface of the occlusal block support is configured to extend into an interproximal region between two teeth of an opposing arch.

13. The orthodontic treatment system of claim 1, wherein the first occlusal block is a posterior occlusal block of the first appliance of the set of appliances and wherein the first appliance of the set of appliances includes a first anterior occlusal block having a distal surface shaped to engage with the second appliance of the set of appliances.

14. The orthodontic treatment system of claim 13, wherein the second occlusal block is a posterior occlusal block of the second appliance of the set of appliances and wherein the second appliance of the set of appliances includes a second anterior occlusal block having a distal surface shaped to engage with the second appliance of the set of appliances.

15. The orthodontic treatment system of claim 14, wherein the distal surface of the first anterior occlusal block is shaped to engage with the distal surface of the second anterior occlusal block.

16. The orthodontic treatment system of claim 1, wherein the first surface includes an attachment receiving cavity shaped to receive and apply orthodontic movement forces to an attachment on an occlusal surface of the teeth.

17. An orthodontic appliance system comprising:
a first polymeric orthodontic appliance to implement a mesial-distal correction according to a first stage of an orthodontic treatment plan on a first arch, wherein the first polymeric orthodontic appliance includes a first occlusal block, wherein the first occlusal block has a first surface with a first shape to match a first occlusal surface of the first arch; and
a second polymeric orthodontic appliance to implement the mesial-distal correction according to the first stage of an orthodontic treatment plan on a second arch opposing the first arch, wherein the second polymeric orthodontic appliance includes a second occlusal block, wherein the second occlusal block has a second surface with a second shape to match a second occlusal surface of the second arch.

18. The orthodontic appliance system of claim 17 wherein the first polymeric orthodontic appliance comprises a first plurality of additively formed layers, the second polymeric orthodontic appliance comprises a second plurality of additively formed layers, or some combination thereof.

19. The orthodontic appliance system of claim 17, wherein:
the first stage of the orthodontic treatment plan comprises instructions for the mesial-distal correction and for repositioning teeth in the first arch from a first arrangement toward a second arrangement;
the first polymeric orthodontic appliance comprises a first plurality of tooth receiving cavities to reposition the teeth in the first arch from the first arrangement toward the second arrangement in accordance with the first stage of the treatment plan.

20. The orthodontic appliance system of claim 17, wherein the first polymeric orthodontic appliance comprises a first plurality of tooth receiving cavities to reposition teeth in the first arch from a first arrangement toward a second arrangement; and
the first polymeric orthodontic appliance comprises a first plurality of additively formed layers, at least some of the first plurality of additively formed layers being through the first occlusal block and the first plurality of tooth receiving cavities.
